(19) United States
(12) Patent Application Publication
(10) Pub. No.: US 2025/0083023 A1
(43) Pub. Date: Mar. 13, 2025

(54) INFORMATION PROCESSING APPARATUS, INFORMATION PROCESSING SYSTEM, INFORMATION PROCESSING METHOD, NON-TRANSITORY RECORDING MEDIUM, AND INFORMATION PROCESSING METHOD

(71) Applicants: Tsutomu Kawase, Kanagawa (JP); Atsushi Ikeda, Kanagawa (JP); Hayato Watanabe, Kanagawa (JP); Kyosuke Suzuki, Kanagawa (JP)

(72) Inventors: Tsutomu Kawase, Kanagawa (JP); Atsushi Ikeda, Kanagawa (JP); Hayato Watanabe, Kanagawa (JP); Kyosuke Suzuki, Kanagawa (JP)

(73) Assignee: Ricoh Company, Ltd., Tokyo (JP)

(21) Appl. No.: 18/822,804

(22) Filed: Sep. 3, 2024

(30) Foreign Application Priority Data
Sep. 12, 2023 (JP) 2023-147931

(51) Int. Cl. A63B 71/06; G02B 27/01

(52) U.S. Cl. CPC A63B 71/0622; G02B 27/017; A63B 2071/0644; G02B 2027/0178

(57) ABSTRACT

An information processing apparatus includes circuitry to play a moving image displayed on a display according to a motion state of a user and control a playback of the moving image and a screen of the display based on a script including a first command and a second command. The first command describes controlling the playback of the moving image in association with a first playback time of the moving image. The second command describes controlling the screen of the display in association with a second playback time of the moving image.

### CROSS-REFERENCE TO RELATED APPLICATIONS

This patent application is based on and claims priority pursuant to 35 U.S.C. § 119 (a) to Japanese Patent Application No. 2023-147931, filed on Sep. 12, 2023, in the Japan Patent Office, the entire disclosure of which is hereby incorporated by reference herein.

### BACKGROUND

### Technical Field

The present disclosure relates to an information processing apparatus, an information processing system, a non-transitory recording medium, and an information processing method.

### Related Art

A known information processing apparatus allows a user viewing a playback image displayed on a display to have a sense of various outdoor experiences by varying the playback image according to the walking state of the user.

Further, a technique for outputting audio according to the progress of a moving image such as a playback image is disclosed. The technique allows a user to perform a walking exercise and experience, for example, a realistic feeling of taking a walk.

### SUMMARY

According to an aspect of the present disclosure, an information processing apparatus includes circuitry to play a moving image displayed on a display according to a motion state of a user and control a playback of the moving image and a screen of the display based on a script including a first command and a second command. The first command describes controlling the playback of the moving image in association with a first playback time of the moving image. The second command describes controlling the screen of the display in association with a second playback time of the moving image.

According to an aspect of the present disclosure, an information processing system includes the above-described information processing apparatus, and a server communicably connected to the information processing apparatus and including additional circuitry. The additional circuitry transmits the moving image and the script to the information processing apparatus in response to a request from the information processing apparatus.

According to an aspect of the present disclosure, a non-transitory recording medium storing a plurality of instructions which, when executed by one or more processors, causes the processors to perform a method. The method includes playing a moving image displayed on a display according to a motion state of a user and controlling playback of the moving image and a screen of the display based on a script including a first command and a second command. The first command describes the controlling the playback of the moving image in association with a first playback time of the moving image. The second command describes the controlling the screen of the display in association with a second playback time of the moving image.

According to an aspect of the present disclosure, an information processing method. The method includes playing a moving image on a display according to a motion state of a user, acquiring a first playback time of the moving image, acquiring a second playback time of the moving image, executing a first command to control playback of the moving image displayed on the display in association with the first playback time, and executing a second command to control a screen of the display in association with the second playback time. The first command and the second command are described in a script.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an example of an information processing system according to a first embodiment of the present disclosure;

FIG. 2 is a schematic diagram illustrating an information processing system according to a first variation of the first embodiment of the present disclosure;

FIG. 3 is a schematic diagram illustrating an information processing system according to a second variation of the first embodiment of the present disclosure;

FIG. 4 is a schematic diagram illustrating an information processing system according to a third variation of the first embodiment of the present disclosure;

FIG. 5 is a block diagram illustrating an example of a hardware configuration of the information processing apparatus according to the first embodiment of the present disclosure;

FIG. 6 is a block diagram illustrating an example of a functional configuration of an information processing apparatus included in the information processing system according to the first embodiment of the present disclosure;

FIG. 7 is a diagram illustrating an example of a user information file in the information processing system according to the first embodiment of the present disclosure;

FIG. 8 is a diagram illustrating an example of a script group in the information processing system according to the first embodiment of the present disclosure;

FIG. 9 is a diagram illustrating an example of a thumbnail group of a script in the information processing system according to the first embodiment of the present disclosure;

FIG. 10 is a diagram illustrating a moving image group in the information processing system according to the first embodiment of the present disclosure;

FIG. 11 is a diagram illustrating an example of a script in the information processing system according to the first embodiment of the present disclosure;

FIG. 12 is a flowchart illustrating an example of the overall operation of the information processing system according to the first embodiment of the present disclosure;

FIG. 13 is a flowchart illustrating an example of a process performed by a playback control unit according to the first embodiment of the present disclosure;

FIG. 14A is a first flowchart illustrating an example of a process performed by a script processing unit according to the first embodiment of the present disclosure;

FIG. 14B is a second flowchart illustrating an example of a process performed by the script processing unit according to the first embodiment of the present disclosure;

FIG. 14C is a third flowchart illustrating an example of a process performed by the script processing unit according to the first embodiment of the present disclosure;

FIG. 14D is a fourth flowchart illustrating an example of a process performed by the script processing unit according to the first embodiment of the present disclosure;

FIG. 15 is a diagram illustrating a first example of a screen of a moving image displayed in the information processing system according to the first embodiment of the present disclosure;

FIG. 16 is a diagram illustrating a second example of a screen of a moving image displayed in the information processing system according to the first embodiment of the present disclosure;

FIG. 17 is a diagram illustrating a third example of a screen of a moving image displayed in the information processing system according to the first embodiment of the present disclosure;

FIG. 18 is a block diagram illustrating an example of a functional configuration of a computer according to a second embodiment of the present disclosure;

FIG. 19 is a flowchart illustrating an example of the overall processing by the computer according to the second embodiment of the present disclosure;

FIG. 20 is a flowchart illustrating an example of a row editing process performed by a script editing unit according to the second embodiment of the present disclosure;

FIG. 21 is a diagram illustrating an example of a script creation screen displayed by the computer according to the second embodiment of the present disclosure; and

FIG. 22 is a diagram illustrating an example of a configuration of an information processing system according to a third embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing apparatus, an information processing system, and a program according to embodiments of the present disclosure are described below in detail with reference to the drawings. However, the following embodiments are merely examples of an information processing apparatus, an information processing system, and a program for embodying the technical idea of the present disclosure, and the present disclosure is not limited to the following embodiments. In the following description, the same names and reference numerals denote the same or similar members or functions, and detailed description thereof will be appropriately omitted.

### First Embodiment

### Configuration of Information Processing System 100

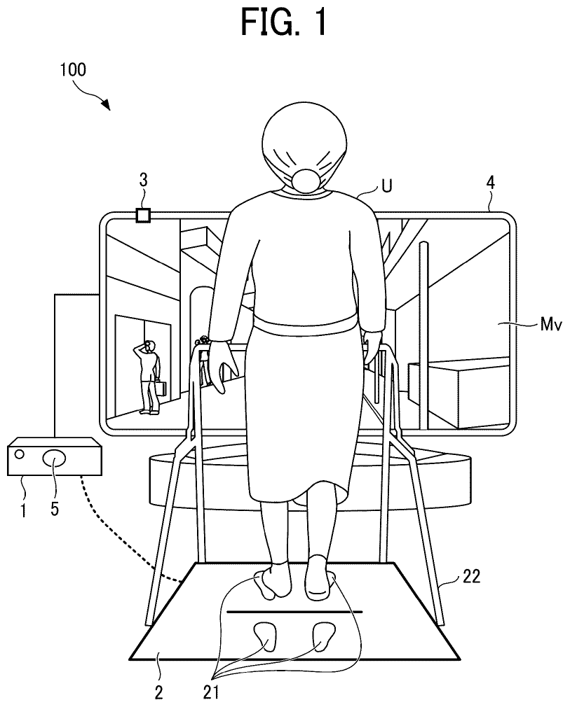

FIG. 1 is a schematic diagram illustrating an example of an information processing system 100 according to a first embodiment of the present disclosure.

The information processing system 100 is a system that promotes exercise of a user U who uses the information processing system 100. The information processing system 100 controls the playback of a moving image Mv displayed on a display 4 according to the motion state of the user U. For example, the information processing system 100 increases the playback speed of the moving image Mv when the walking speed of the user U is high, and decreases the playback speed of the moving image Mv when the walking speed of the user U is low. Alternatively, the information processing system 100 plays the moving image Mv in the forward direction when the user U moves forward, and plays the moving image Mv in the reverse direction when the user U moves backward. The moving image Mv is, for example, a moving image obtained by capturing scenery that comes into the field of view of a pedestrian while walking at a tourist site.

The user U visually recognizes the moving image Mv that changes in the playback speed according to the walking speed of the user U and changes in the playback direction according to the walking direction of the user U, through the display 4. This allows the user U to have a simulated experience as if he or she was walking around a tourist site. Accordingly, the information processing system 100 can encourage the user U to walk while enjoying the exercise without getting bored.

As illustrated in FIG. 1, the information processing system 100 includes an information processing apparatus 1 and a motion sensor 2 that outputs motion state information indicating a motion state of the user U. In the example illustrated in FIG. 1, the information processing system 100 includes a gaze sensor 3 that detects the line of sight of the user U.

The motion sensor 2 includes a pressure sensor 21 that detects pressure of, for example, the sole of each foot when the user U steps, and a support member 22 that the user U can hold when exercising.

The motion sensor 2 outputs a pressure detection signal from the pressure sensor 21 to the information processing apparatus 1 as motion information regarding the motion state of the user U. The motion sensor 2 may be an acceleration sensor or an optical sensor that detects stepping motion.

The gaze sensor 3 detects the line of sight of the user U and outputs gaze information regarding the line of sight of the user U to the information processing apparatus 1. The gaze sensor 3 includes a camera and an image processing circuit. The gaze sensor 3 detects, with the image processing circuit, the line of sight of the user U by specifying the position of the image region of the pupil included in the facial image of the user U. The facial image is captured by the camera. The gaze sensor 3 may be a direction key or a joystick of an operation device 6 operated by a user.

The information processing apparatus 1 acquires information on the walking speed of the user U from the motion information input from the motion sensor 2. The information processing apparatus 1 obtains a cycle in which the user U steps on the pressure sensor 21 based on the motion information, and obtains the walking speed of the user U from the cycle by calculation. The information processing apparatus 1 detects the walking direction of the user U by detecting whether the user U steps on the pressure sensor 21 for forward movement or the pressure sensor 21 for backward movement. For example, the information processing apparatus 1 varies the playback speed or the playback direction of the moving image Mv displayed on the display 4 according to the walking speed or walking direction of the user U. The display 4 may be a liquid crystal display or an organic electro luminescence (EL) display, or a plasma display.

In the example illustrated in FIG. 1, the information processing apparatus 1 varies the image area of the moving image Mv displayed on the display 4 according to the gaze information from the gaze sensor 3. For example, when the line of sight of the user U is directed in a right direction, the information processing apparatus 1 controls the playback of the moving image Mv so that the center of the right image area of the entire image area of the moving image Mv is displayed at the center of the screen of the display 4. The user U can feel the simulated walking experience more realistically by visually recognizing the moving image Mv in which the image area displayed on the display 4 changes according to the gaze direction of the user U.

In the example illustrated in FIG. 1, the information processing system 100 includes a speaker 5 that generates audio. The speaker 5 is incorporated in the information processing apparatus 1. The information processing system 100 cause the speaker 5 to generate the audio to match the moving image Mv displayed on the display 4. For example, when the moving image Mv includes scenery visible when walking through a stone tatami, the information processing system 100 causes the speaker 5 to generate the sound of footsteps of walking on the stone tatami. This allows the user U to experience a more realistic simulated experience by using the sense of hearing.

The user U can perform a walking exercise while enjoying scenery by receiving, for example, motion stimulus, visual stimulus, and auditory stimulus through the moving image Mv, which changes according to the motion information from the motion sensor 2 and the gaze information from the gaze sensor 3.

### Example of Variation

The information processing system according to the first embodiment of the present disclosure is not limited to the example illustrated in FIG. 1, and various variations are possible. Various variations are described below. In the following description, the same names and reference numerals denote the same or similar members or configurations, and detailed description thereof is appropriately omitted. This also applies to the variations and embodiments described below.

### First Variation

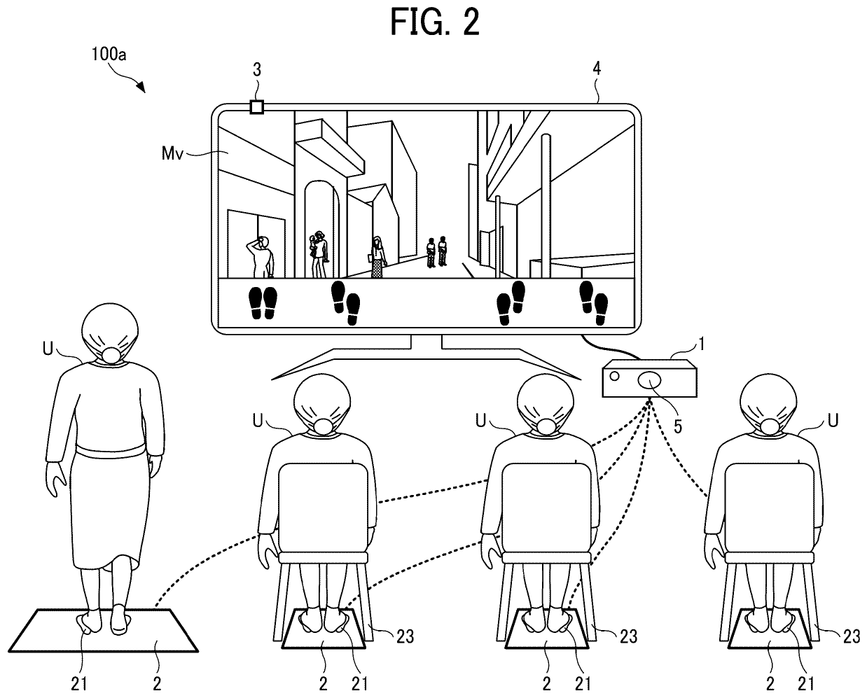

FIG. 2 is a schematic diagram illustrating an information processing system 100a according to a first variation. The first variation is different from the information processing system 100 illustrated in FIG. 1 in that multiple users U can use the information processing system 100a in parallel. Since the multiple users U can use the information processing system 100a in parallel, the multiple users U can share a simulated experience such as walking. This allows the users U to exercise while enjoying the experience more than when each of the users U uses the information system alone.

In the example illustrated in FIG. 2, four users U use the information processing system 100a. The motion sensor 2 is prepared for each of the four users U. In other words, the number of the motion sensors 2 is four. The information processing apparatus 1 can acquire the motion information of each of the four users U from the corresponding motion sensor 2. In the information processing system 100a, the moving image Mv visually recognized by each of the four users U is displayed on the single display 4, and thus the moving image Mv visually recognized by each of the users U can be shared among the four users U.

The multiple users U can exercise leading to rehabilitation while remembering and talking about a scene or talking about impressions among the multiple users U by using the information processing system 100a in parallel.

The number of displays 4 connected to the information processing apparatus 1 may be multiple. This allows the users U on different floors to perform the exercise by sharing the moving image Mv.

In the example illustrated in FIG. 2, one of the users U is walking while standing, and the other three or the users U are walking while sitting on chairs 23. In this way, the information processing system 100a can select the walking exercise in the standing state or the walking exercise in the sitting state according to the preference or the health condition of each of the users U.

### Second Variation

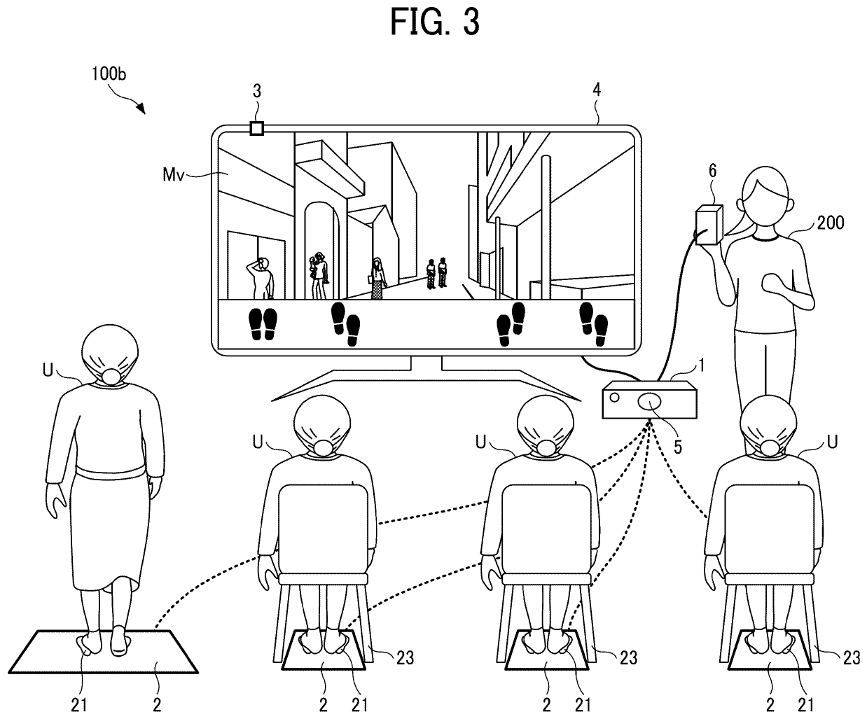

FIG. 3 is a schematic diagram illustrating an information processing system 100b according to a second variation. The second variation is different from the first variation in that an operator 200 different from the users U can operate the information processing system 100b. The operator 200 is, for example, a caregiver who provides care to individuals who are the users U receiving care. When the operator 200 operates the information processing system 100b, which is operable by the operator 200, the time and effort of the operation of the users U can be reduced, and the operation of the information processing system 100b can be smoothly performed. This can increase the motivation of the users U to use the information processing system 100b and promote the users U to exercise.

The operator 200 uses the operation device 6 to select a moving image to be displayed on the display 4 and input an instruction to start, stop, or resume the playback of the moving image. As the operation device 6, a touch panel, an operation button, a keyboard, a joystick, or a combination thereof can be used. The operation device 6 may be a remote controller that is detachable from the information processing system 100 or the information processing apparatus 1. The operation device 6 may be an information processing terminal such as a tablet or a smartphone.

### Third Variation

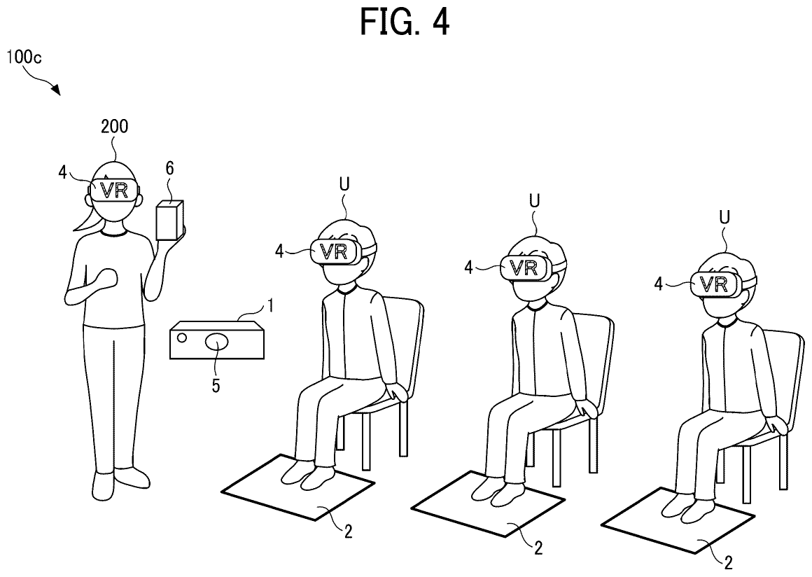

FIG. 4 is a schematic diagram illustrating an information processing system 100c according to a third variation. The third variation is different from the second variation in that the display 4 is a virtual reality (VR) glasses. The VR glasses are an example of a head-mounted display device. By using the VR glasses for the display 4, the user U can have a more realistic simulated experience, and this can prompt the users U to exercise.

The VR glasses may be a head-mounted display device. The VR glasses are not limited to a goggle type illustrated in FIG. 4, and may be a glasses type (glasses-type display device).

### Example of Configuration of Information Processing Apparatus 1 Hardware Configuration

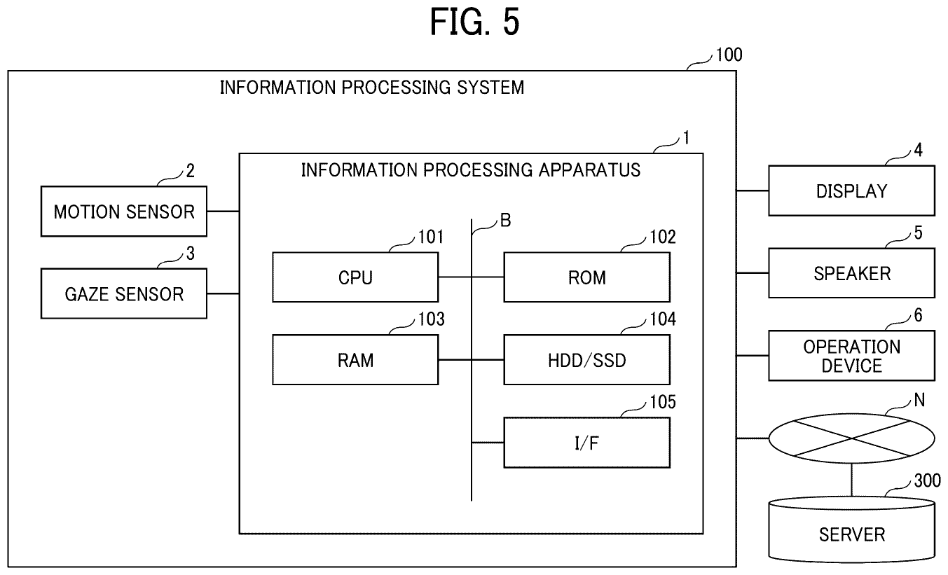

FIG. 5 is a block diagram illustrating an example of a hardware configuration of the information processing apparatus 1. The information processing apparatus 1 is implemented by a computer. The information processing apparatus 1 includes a central processing unit (CPU) 101, a read-only memory (ROM) 102, a random access memory (RAM) 103, a hard disk drive (HDD)/solid state drive (SSD) 104, and an interface (I/F) 105. The above-described components are communicably connected to each other via a system bus B.

The CPU 101 controls various arithmetic operations. The ROM 102 is a non-volatile memory in which programs such as an initial program loader (IPL) used for booting the CPU 101 are stored. The RAM 103 is a volatile memory used as a working area for the CPU 101. The HDD/SSD 104 is a nonvolatile memory that can store various information and programs used for control of the information processing apparatus 1.

The I/F 105 is an interface for communication between the information processing apparatus 1 and a device or an apparatus other than the information processing apparatus 1. The I/F 105 can also communicate with a device or an apparatus other than the information processing apparatus 1 via a network. The devices other than the information processing apparatus 1 includes the motion sensor 2, the gaze sensor 3, the display 4, the speaker 5, and the operation device 6. The devices other than the information processing apparatus 1 includes a server 300 communicably connected via a network N.

### Functional Configuration

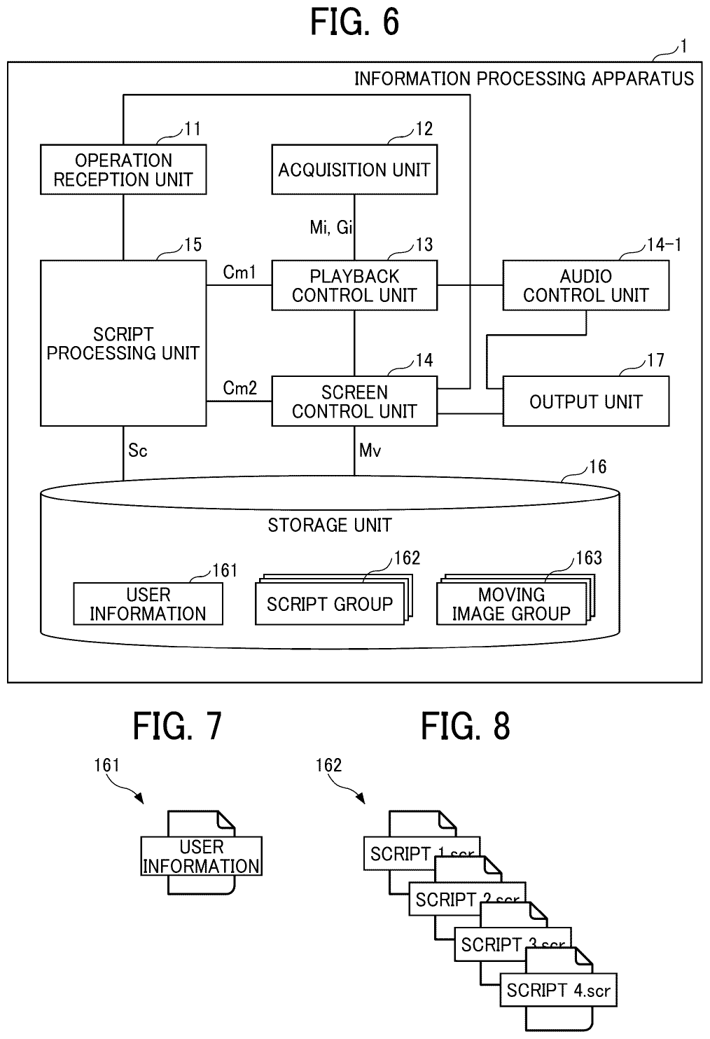

FIG. 6 is a block diagram illustrating an example of a functional configuration of the information processing apparatus 1.

In the example illustrated in FIG. 6, the information processing apparatus 1 includes an operation reception unit 11, an acquisition unit 12, a playback control unit 13, a screen control unit 14, an audio control unit 14-1, a script processing unit 15, a storage unit 16, and an output unit 17.

The functions of the operation reception unit 11, the acquisition unit 12, and the output unit 17 are implemented by, for example, the I/F 105. A part of the functions of the acquisition unit 12 and the output unit 17 may be implemented by a processor such as the CPU 101 executing processing defined in a program stored in the ROM 102. The function of the storage unit 16 is implemented by, for example, the RAM 103 or the HDD/SSD 104. The function of each of the playback control unit 13, the screen control unit 14, and the script processing unit 15 is implemented by a processor such as the CPU 101 executing processing defined in a program stored in the ROM 102.

Each function of the information processing apparatus 1 can be implemented by one or more processing circuits.

The “processing circuit” includes devices such as an application-specific integrated circuit (ASIC), a field-programmable gate array (FPGA), a digital signal processor (DSP), and a conventional circuit module designed to execute one or more of the functions described above. Further, some of the functions of the information processing apparatus 1 may be implemented by an external apparatus such as an external personal computer (PC) or a server that is communicably connected to the information processing apparatus 1. Further, some of the functions of the information processing apparatus 1 may be implemented by distributed processing between the information processing apparatus 1 and such the external apparatus.

The operation reception unit 11 receives various operations performed by the operator using the operation device 6 by controlling the communication of the operation device 6. The operations in relation to the example illustrated in FIG. 6 includes selecting information on the user U who uses the information processing system 100, selecting a script Sc, selecting a moving image Mv, and starting and stopping of the playback of the moving image Mv.

The acquisition unit 12 acquires motion information Mi of the user U from the motion sensor 2 by communication with the motion sensor 2. The acquisition unit 12 acquires gaze information Gi of the user U from the gaze sensor 3 by communication with the gaze sensor 3. The acquisition unit 12 passes the acquired motion information Mi and gaze information Gi to the playback control unit 13.

The playback control unit 13 controls the playback of the moving image Mv displayed on the display 4 according to the motion state of the user U. In the example illustrated in FIG. 6, the playback control unit 13 causes the display 4 to display, via the screen control unit 14, the moving image Mv at a playback speed or in a playback direction corresponding to the motion state of the user U obtained from the motion information Mi.

The screen control unit 14 controls the screen of the display 4. In the example illustrated in FIG. 6, the screen control unit 14 controls the screen of the display 4 by outputting, to the display 4 via the output unit 17, a signal for controlling the display operation of the display 4. The screen control unit 14 receives information on a moving image Mv selected by the operator via the operation reception unit 11 and acquires the moving image Mv from the storage unit 16 based on the information. The screen control unit 14 causes the display 4 to display the moving image Mv whose playback is controlled by the playback control unit 13.

The audio control unit 14-1 controls audio output from the speaker 5. In the example illustrated in FIG. 6, the audio control unit 14-1 controls the audio output by the speaker 5 by outputting, to the speaker 5 via the output unit 17, a signal for controlling audio output operation of the speaker 5.

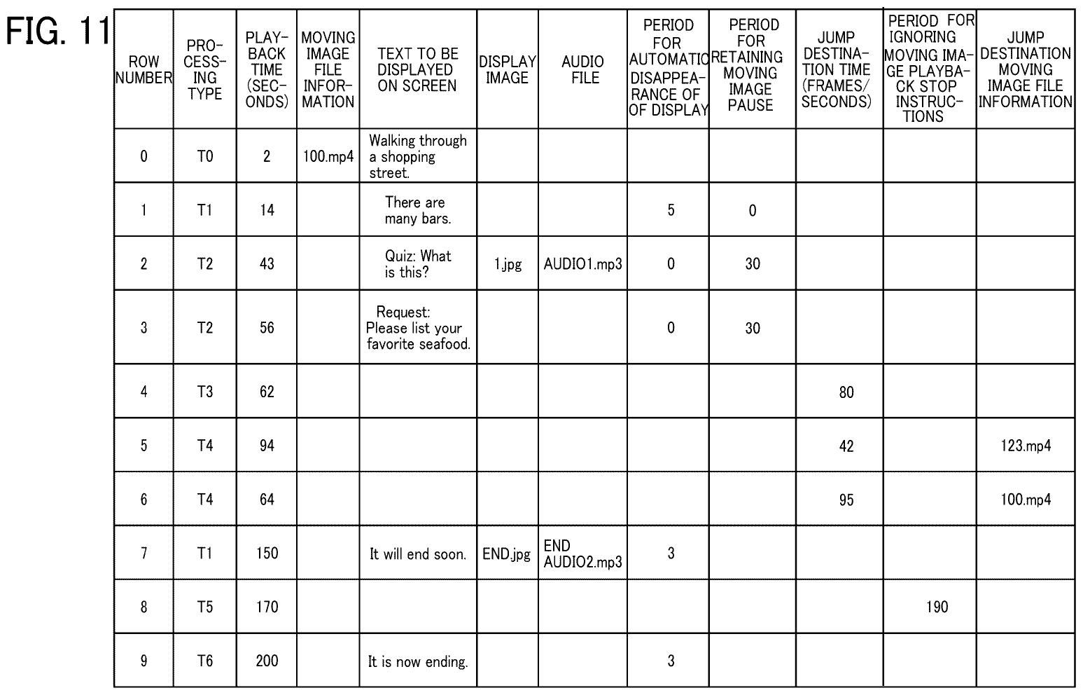

The script processing unit 15 directs the playback control unit 13 and the screen control unit 14 to perform control based on a script Sc in which a first command Cm1 to control the playback of the moving image Mv in association with a specific playback time (first playback time) of the moving image Mv and a second command Cm2 to control the screen in association with a specific playback time (second playback time) of the moving image Mv are described. A specific example of a script Sc is described later with reference to FIG. 8.

In the description of the present embodiment, a “playback time of a moving image Mv” refers to a time calculated from the start of the moving image Mv. However, the “playback time of a moving image Mv” does not mean the actual elapsed time since the start of playback of the moving image Mv, but represents the sequence (position) of images within the moving image MV. For example, in a case where the frame rate of the moving image Mv is Fs and the playback time is Rp, the playback time Rp represents the sequence (position) of the (Rp/Fs)th image in the moving image Mv, among the multiple images included in the moving image Mv, based on the frame rate, starting from the playback start time. Accordingly, the playback time of the moving image Mv can also be expressed as a playback position. The playback time may also be referred to as a point or a mark in the playback. On the other hand, in the description of the present embodiment, an “elapsed playback time of a moving image Mv” refers to an actual elapsed time since the start of the playback of the moving image Mv. The “moving image duration” refers to the total time taken to play the entire moving image Mv.

The storage unit 16 stores the scripts Sc. In the example illustrated in FIG. 6, the storage unit 16 stores user information 161 in which various pieces of information related to each of the multiple users U are recorded, a script group 162 including multiple scripts Sc associated with multiple moving images Mv, and a moving image group 163 including the multiple moving images Mv.

The storage unit 16 may not be provided in the information processing apparatus 1, but may be provided in the server 300 illustrated in FIG. 5. In this case, the screen control unit 14 and the script processing unit 15 acquire the user information 161, the script Sc, and the moving image Mv via the network N. Further, the information processing apparatus 1 may store a part of the user information 161, the script group 162, and the moving image group 163, and the server 300 may store the other part.

The output unit 17 controls communication between the information processing apparatus 1 and an external device in response to an instruction from the screen control unit 14. The external device includes the display 4, the speaker 5, the operation device 6, and the server 300.

The interest of the user U may varies depending on, for example, his or her hometown, life, living environment, work, or family condition. Further, when the operator 200 is present, the interest of the operator 200 varies depending on his or her experience. Further, a period for using the information processing system 100 may vary depending on, for example, the physical strength and physical ability of the user U. Accordingly, it is preferable to provide the moving image Mv according to the interest of the user U or the operator 200. However, when the user U or the operator 200 tries to edit a moving image according to his or her interest, a tool such as editing software or an editing skill may be required for editing the moving image, and editing according to his or her will may not be easily performed.

In the information processing apparatus 1, the script processing unit 15 directs the playback control unit 13 and the screen control unit 14 to perform control based on a script Sc. Under the control of the playback control unit 13 and the screen control unit 14, the moving image Mv can be displayed with, for example, a comment, a quiz, or an image used for a quiz in a superimposed manner according to a command, or the moving image duration of the moving image Mv can be adjusted by deleting an image other than one to pay attention in the moving image Mv or by connecting different moving images according to a command, without editing the moving image Mv in advance. Further, by using the scripts Sc, a script Sc can be created for each of the multiple users U and each of multiple operators 200. A script can also be created for multiple users U or multiple operators 200. As a result, the information processing apparatus 1 and the information processing system 100 can easily provide a moving image Mv suitable for each user U or each operator 200.

In the example illustrated in FIG. 6, the script processing unit 15 directs the playback control unit 13 and the screen control unit 14 to perform control based on the script Sc stored in the storage unit 16 included in the information processing apparatus 1. The information processing apparatus 1 includes the storage unit 16, and thus, access to the script Sc is facilitated, compared to a case where the storage unit 16 is provided in an external device such as the server 300.

In the example illustrated in FIG. 6, the storage unit 16 stores a script Sc corresponding to the user U and a script Sc corresponding to a group of the multiple users U. The script processing unit 15 acquires the script Sc corresponding to one of the user U or the group of the multiple users U by referring to the storage unit 16 in response to a selection input indicating the one of the user U or the group of the multiple users U. By so doing, the moving image Mv that is suitable for the one of the user U or the group of the multiple users U can be easily provided.

The first embodiment of the present disclosure includes a program. The program causes the computer to execute processing for controlling the playback of the moving image Mv displayed on the display 4 according to the motion state of the user U by the playback control unit 13 and controlling the screen of the display 4 by the screen control unit 14. The program causes the computer to execute, by the script processing unit 15, processing for directing the playback control unit 13 and the screen control unit 14 to perform control based on the script Sc in which the first command Cm1 for causing the playback control unit 13 to control the playback of the moving image Mv in association with a specific playback time (first playback time) of the moving image Mv and the second command Cm2 for causing the screen control unit 14 to control the display in association with a specific playback time (second playback time) are described. With such a program, the same operation and effect as those of the information processing apparatus 1 and the information processing system 100 described above can be obtained.

### Example of Information Stored in Storage Unit 16

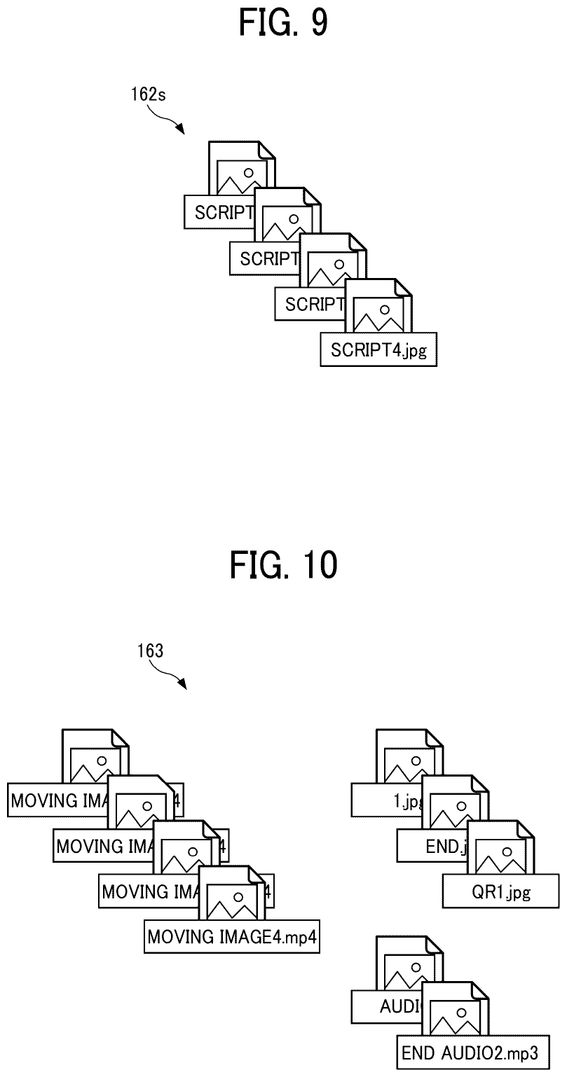

Information stored in the storage unit 16 in the information processing system 100 is described with reference to FIGS. 7 to 10.

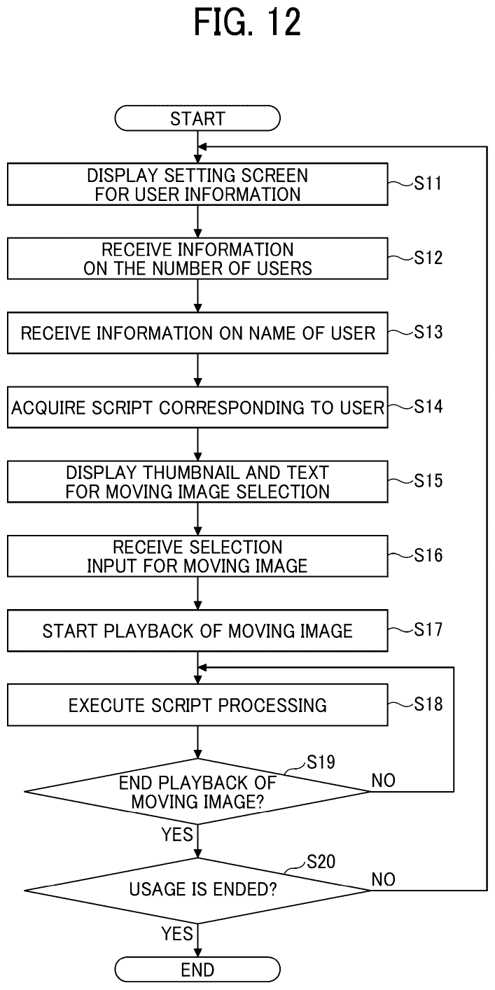

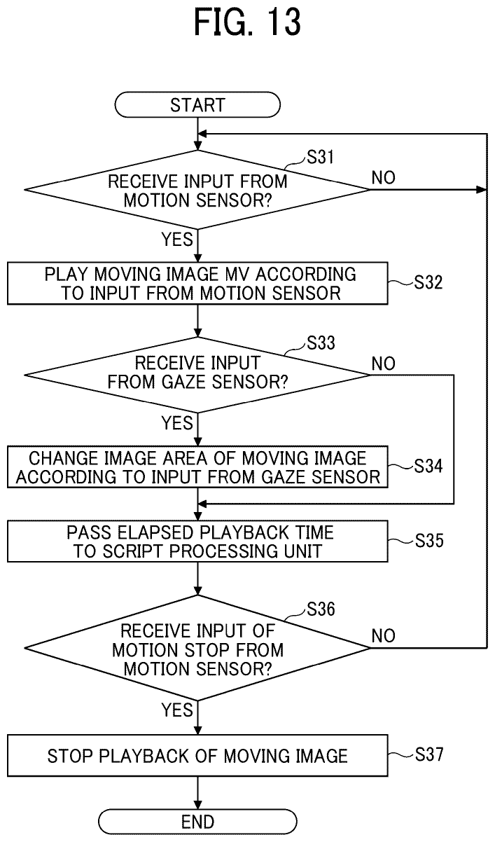

FIG. 7 is a diagram illustrating an example of the user information 161. FIG. 8 is a diagram illustrating an example of the script group 162. FIG. 9 is a diagram illustrating an example of a thumbnail group 162s in the script group 162. FIG. 10 is a diagram illustrating an example of the moving image group 163. The moving image group 163 includes multiple electronic files corresponding to the multiple moving images Mv.

The user information 161 is an electronic file in which information of each of the multiple users U is recorded. The script group 162 includes multiple electronic files corresponding to the multiple scripts Sc. The extension of the file of the script Sc is, for example, “scr.” The thumbnails included in the thumbnail group 162s are electronic files of images that record images used for allowing the user to easily recognize the content of a moving image Mv when the user selects the moving image Mv.

The extension of the image file of the thumbnail is, for example, “jpg.” The extension of the moving image Mv is, for example, “mp4.”

In the example illustrated in FIG. 10, the moving image group 163 includes an image file “1.jpg” to be displayed on the display 4 before the moving image playback starts, an image file “END.jpg” to be displayed on the display 4 after the moving image playback ends, and “QR1.jgp” for displaying a QR code. The moving image group 163 includes an audio file “AUDIO1.mp3” to be output from the speaker 5 before the moving image playback starts and an audio file “END AUDIO2.jpg” to be output from the speaker 5 after the moving image playback ends.

### Example of Script Sc

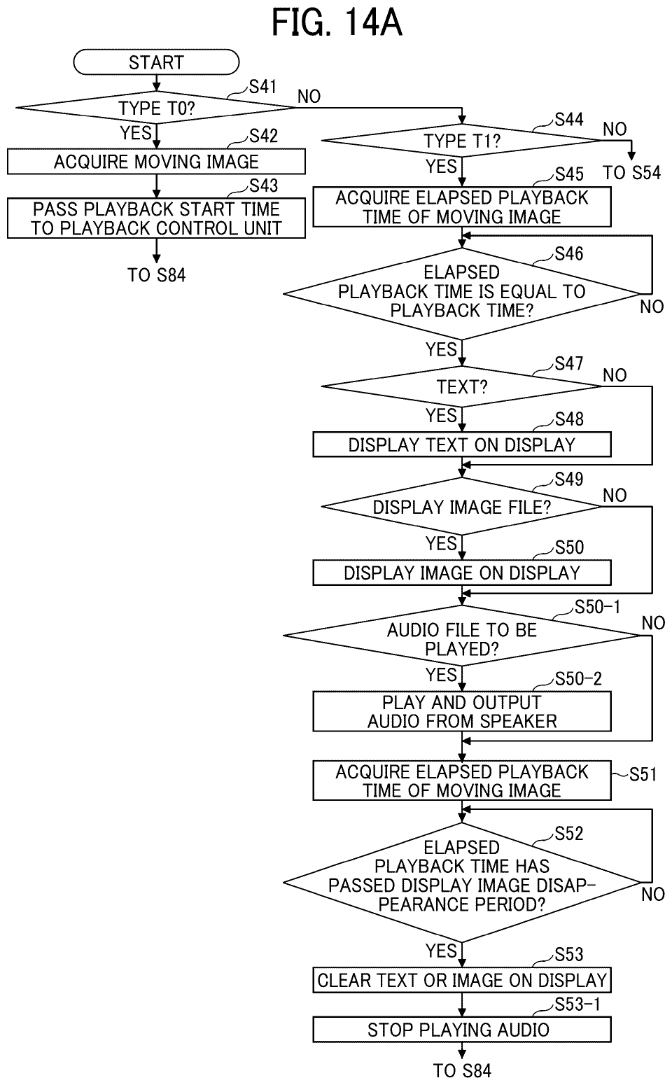

FIG. 11 is a diagram illustrating an example of a script Sc in the information processing system 100. In the example illustrated in FIG. 11, the script Sc is in a table format. In each row of the table, the first command Cm1 or the second command Cm2 is described. Each row of the table indicates processing including the first command Cm1 or the second command Cm2.

Each column of the table corresponds to a specific item. In the columns of the table, “ROW NUMBER” is a number indicating a row in the table of the script Sc. “PROCESSING TYPE” indicates a type (in other words, classification) of processing to be performed in association with or at a playback time of the moving image Mv. The content of processing to be performed for each “processing type” is determined in advance. “PLAYBACK TIME (SECONDS)” indicates a playback time for performing predetermined processing on the moving image Mv. “MOVING IMAGE FILE INFORMATION” indicates the file name of the moving image Mv. “TEXT TO BE DISPLAYED ON SCREEN” indicates the content of a text such as characters or numerals to be displayed on the screen of the display 4. “DISPLAY IMAGE” indicates the file name of an image to be displayed on the display 4 in the playback of the moving image Mv.

“AUDIO FILE” indicates the file name of a file in which audio information to be output from the speaker 5 is recorded. “PERIOD FOR AUTOMATIC DISAPPEARANCE OF DISPLAY” indicates a time period after which a text or an image displayed on the display 4 during the script processing automatically disappears (is cleared).

“PERIOD FOR RETAINING MOVING IMAGE PAUSE” indicates a time period for which a text or an image displayed on the display 4 is retained in the script processing. “JUMP DESTINATION TIME (FRAMES/SECONDS)” indicates a playback time of a jump destination when the time of the playback is jumped. “PERIOD FOR IGNORING MOVING IMAGE PLAYBACK STOP INSTRUCTIONS” indicates a time period during which a playback stop instruction for the moving image Mv is ignored. “JUMP DESTINATION MOVING IMAGE FILE INFORMATION” indicates the file name of an additional moving image file when the additional moving image file is to be played by interrupting.

In the “PROCESSING TYPE” of FIG. 11, Type T0 indicates processing of recording the explanation text of a thumbnail and specifying the file information of the moving image Mv and the time to start the playback of the moving image Mv.

Type T1 indicates processing of displaying a text or an image on the display 4 if there is any one to be displayed when the elapsed playback time of the moving image Mv reaches a specified playback time, playing the moving image Mv according to the motion state of the user U, and clearing an object such as the text or the image, displayed on the display 4 when a time period specified in the “PERIOD FOR AUTOMATIC DISAPPEARANCE OF DISPLAY” has elapsed.

Type T2 indicates processing of displaying a text or an image on the display 4 if there is any one to be displayed when the elapsed playback time of the moving image Mv reaches a specified playback time, stopping the playback of the moving image Mv regardless of the motion state of the user U, and resuming the playback of the moving image Mv according to the motion state of the user U when a time period specified in the “PERIOD FOR RETAINING MOVING IMAGE PAUSE” has elapsed.

Type T3 indicates processing of stopping the playback of the current moving image Mv and jumping the playback of the moving image to a playback time specified in the “JUMP DESTINATION TIME (FRAMES/SECONDS)” when the elapsed playback time of the moving image Mv reaches a specified playback time.

Type T4 indicates processing of stopping the playback of the current moving image Mv when the elapsed playback time of the moving image Mv reaches a specified playback time, and jumping the playback of the moving image to a time specified in the “JUMP DESTINATION TIME (FRAMES/SECONDS)” in a moving image file specified in the “JUMP DESTINATION MOVING IMAGE FILE INFORMATION.”

Type T5 indicates processing of directing the playback control unit 13 to ignore an instruction for stopping the moving image Mv when the elapsed playback time of the moving image Mv reaches a specified playback time, and accepting the instruction for stopping the playback of the moving image Mv according to the motion state of the user U when a time period specified in the “PERIOD FOR IGNORING MOVING IMAGE PLAYBACK STOP INSTRUCTIONS” has elapsed.

Type T6 indicates processing of ending the playback of the moving image Mv when the elapsed playback time of the moving image Mv reaches a specified playback time.

In the processing (row) illustrated in FIG. 11, the first command Cm1 corresponds to a command for causing the playback control unit 13 to control the playback, such as a command to jump the playback to “JUMP DESTINATION TIME (FRAMES/SECONDS)” and a command to jump the playback to a moving image specified in “JUMP DESTINATION MOVING IMAGE FILE INFORMATION.” In the processing illustrated in FIG. 11, the second command Cm2 corresponds to a command for causing the screen control unit 14 to control the display, such as a command to displaying a text specified in “TEXT TO BE DISPLAYED ON SCREEN” on the screen of the display 4 and a command to display an image specified in “DISPLAY IMAGE” on the screen of the display 4.

The number of items corresponding to the columns of the script Sc may be increased or decreased according to the specification of the information processing system 100. The description format of the script Sc is not limited to a table format, and may be another format such as a code format in which a code is described. The processing types are not limited to the nine classifications illustrated in FIG. 11, and the number of classifications may be increased or decreased according to the specification of the information processing system 100.

### Example of Operation of Information Processing System 100

### Overall Operation

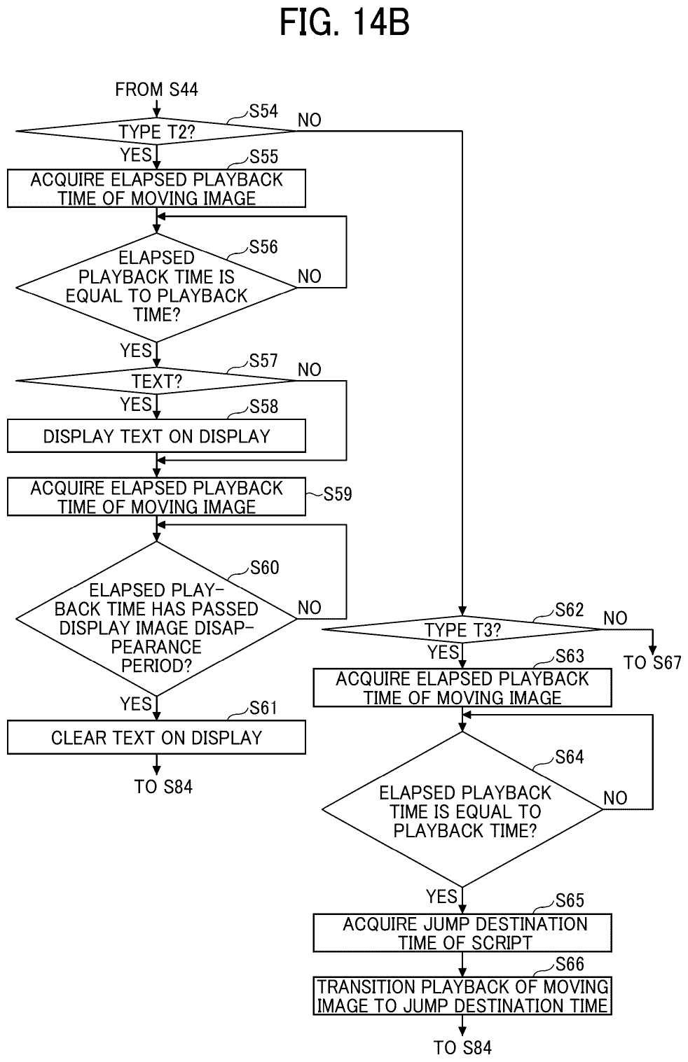

FIG. 12 is a flowchart illustrating an example of an overall operation of the information processing system 100. FIG. 12 illustrates an overview of the operation performed by the information processing system 100 when the user U uses the information processing system 100, in other words, the operation for allowing the user U to use the information processing system 100. For example, the information processing system 100 starts the operation of FIG. 12 on the start condition that the information processing system 100 receives a use start operation of the information processing system 100 by the operator using the operation device 6.

In Step S11, the information processing system 100 causes the display 4 to display a setting screen for user information.

In Step S12, the operation reception unit 11 of the information processing apparatus 1 receives a selection input for the number of users U via the operation device 6.

In Step S13, the operation reception unit 11 of the information processing apparatus 1 receives information on the name of the user U from a operator via the operation device 6. For example, the operator is the user U or the operator 200 illustrated in FIG. 3.

In Step S14, the information processing system 100 acquires a script Sc corresponding to the user U by referring to the storage unit 16 based on the information on the name of the user U.

In Step S15, the screen control unit 14 of the information processing apparatus 1 causes the display 4 to display a thumbnail and a text for moving image selection.

In Step S16, the operation reception unit 11 of the information processing apparatus 1 receives a selection input for a moving image Mv from the operator via the operation device 6.

In Step S17, the information processing system 100 starts the playback of the selected moving image Mv by the playback control unit 13 of the information processing apparatus 1. The screen control unit 14 displays the moving image Mv on the display 4 in response to a command from the playback control unit 13. The information processing system 100 continues the playback of the moving image Mv from Step S17 until the playback of the moving image Mv ends.

Subsequently, in Step S18, the script processing unit 15 of the information processing apparatus 1 executes script processing. The script processing unit 15 directs the playback control unit 13 and the screen control unit 14 to perform control according to the description of each row of the script Sc illustrated in FIG. 11.

Subsequently, in Step S19, the information processing system 100 determines whether to end the playback of the moving image Mv. For example, the information processing system 100 can determine whether to end the playback of the moving image Mv by the screen control unit 14 of the information processing apparatus 1 determining whether the elapsed playback time of the moving image Mv and the moving image duration of the moving image Mv match each other.

When determining in Step S19 that the playback of the moving image Mv does not end (NO in Step S19), the information processing system 100 performs the processing of Step S18 again. On the other hand, when determining that the playback of the moving image Mv ends (YES in Step S19), the information processing system 100 determines whether the usage of the information processing system 100 is ended in Step S20. For example, the information processing system 100 can determine whether the usage of the information processing system 100 is ended according to an operation input by the operator via the operation device 6.

When determining in Step S20 that the usage of the information processing system 100 is not ended (NO in Step S20), the information processing system 100 performs the processing of Step S11 and the subsequent steps again. On the other hand, when determining that the usage is ended (YES in Step S20), the information processing system 100 ends the operation.

As described above, the information processing system 100 can allow the user U to use the information processing system 100. In a case where multiple users U visually view a moving image Mv displayed on a single display 4, the operator 200 can select the moving image Mv or the script Sc common to the multiple users U.

### Playback Process

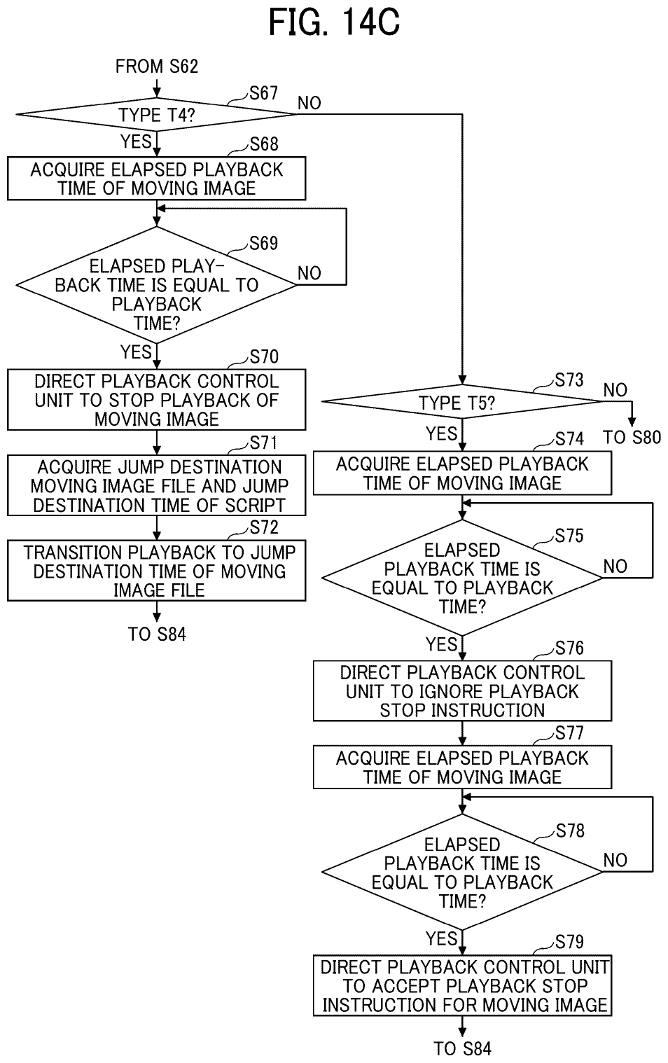

FIG. 13 is a flowchart illustrating an example of a process performed by the playback control unit 13. FIG. 13 illustrates an example of a playback control process of a moving image Mv by the playback control unit 13. For example, the playback control unit 13 starts the operation of FIG. 13 on the condition that the process illustrated in FIG. 12 reaches the Step S17.

First, in Step S31, the playback control unit 13 determines whether there is an input from the motion sensor 2.

When determining in Step S31 that there is no input (NO in Step S31), the playback control unit 13 performs the processing of Step S31 again. On the other hand, when determining that there is an input (YES in Step S31), the playback control unit 13 plays the moving image Mv according to the input from the motion sensor 2 and causes the display 4 to display the moving image Mv via the screen control unit 14 in Step S32.

Subsequently, in Step S33, the playback control unit 13 determines whether there is an input from the gaze sensor 3.

When determining in Step S33 that there is no input (NO in Step S33), the playback control unit 13 proceeds to Step S35. On the other hand, when determining that there is an input (YES in Step S33), the playback control unit 13 changes the image area of the moving image Mv displayed on the display 4 according to the input from the gaze sensor 3 and causes the display 4 to display the moving image Mv via the screen control unit 14 in Step S34.

Subsequently, in Step S35, the playback control unit 13 acquires the elapsed playback time of the moving image Mv and passes the elapsed playback time to the script processing unit 15.

In Step S36, the playback control unit 13 determines whether there is an input of motion stop from the motion sensor 2.

When determining in Step S36 that there is no input (NO in Step S36), the playback control unit 13 performs the processing from Step S31 again. On the other hand, when determining that there is an input (YES in Step S36), the playback control unit 13 stops the playback of the moving image Mv in Step S37. Then, the playback control unit 13 ends the operation.

As described above, the playback control unit 13 can perform the playback process for the moving image Mv.

### Script Processing

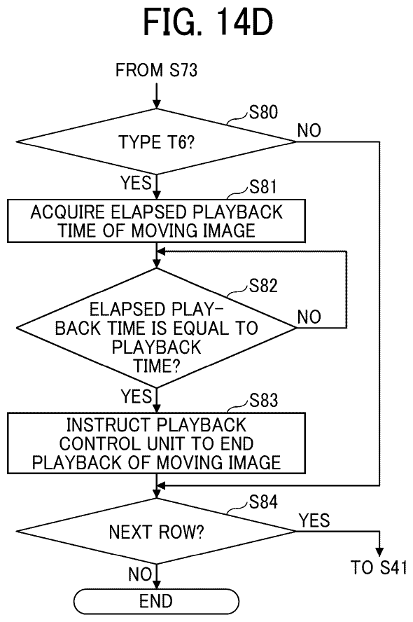

FIGS. 14A to 14D are flowcharts illustrating an example of a process performed by the script processing unit 15. FIGS. 14A to 14D illustrate a procedure in which the script processing unit 15 sequentially executes the processing defined in the rows of the table of the script Sc from the first row based on the script Sc. For example, the playback control unit 13 starts the process of FIGS. 14A to 14D on the condition that the process illustrated in FIG. 12 reaches Step S18.

First, in Step S41, the script processing unit 15 determines whether the processing type is Type T0.

When determining in Step S41 that the processing type is Type T0 (YES in Step S41), the script processing unit 15 acquires the moving image Mv by referring to the storage unit 16 based on the file information of the moving image Mv from the operation reception unit 11 in Step S42.

Subsequently, in Step S43, the script processing unit 15 passes the time at which the playback of the moving image Mv starts (playback start time) to the playback control unit 13. Then, the script processing unit 15 proceeds to Step S84.

On the other hand, when determining in Step S41 that the processing type is not Type

TO (NO in Step S41), the script processing unit 15 determines in Step S44 whether the processing type is Type T1.

When determining in Step S45 that the processing type is Type T1 (YES in Step S44), the script processing unit 15 acquires the current elapsed playback time of the moving image Mv from the playback control unit 13 in Step S45.

Subsequently, in Step S46, the script processing unit 15 determines whether the current elapsed playback time is equal to a playback time defined or specified in the row of the script Sc.

When determining in Step S46 that the elapsed playback time is not equal to the playback time (NO in Step S46), the script processing unit 15 performs the processing of Step S46 again.

On the other hand, when determining that the elapsed playback time is equal to the playback time (YES in Step S46), the script processing unit 15 determines whether there is a text defined in the row of the script Sc in Step S47.

When determining in Step S47 that there is no text (NO in Step S47), the script processing unit 15 proceeds to Step S49. On the other hand, when determining that there is a text (YES in Step S47), the script processing unit 15 passes the text to the screen control unit 14 in Step S48. The screen control unit 14 displays the text passed from the script processing unit 15 on the display 4.

Subsequently, in Step S49, the script processing unit 15 determines whether there is an image file for display (display image file) defined in the row of the script Sc.

In Step S49, when determining that there is no display image file (Step S49, NO), the script processing unit 15 proceeds to Step S51. On the other hand, when determining that there is a display image file (YES in Step S49), the script processing unit 15 passes the display image file to the screen control unit 14 in Step S50. The screen control unit 14 causes the display 4 to display the display image of the display image file passed from the script processing unit 15.

Subsequently, in Step S50-1, the script processing unit 15 determines whether there is an audio file defined in the row of the script Sc. When determining in Step S50-1 that there is no audio file (NO in Step S50-1), the script processing unit 15 proceeds to Step S51. On the other hand, when determining in Step S50-1 that there is an audio file (Step S50-1, YES), the script processing unit 15 causes the audio control unit 14-1 to pass the audio file to the speaker 5 and output the audio from the speaker 5.

Subsequently, in Step S51, the script processing unit 15 acquires the current elapsed playback time of the moving image Mv from the playback control unit 13.

In Step S52, the script processing unit 15 determines whether the current elapsed playback time has passed the display image disappearance period defined in the row of the script Sc.

When determining in Step S52 that the elapsed playback time has not passed the display image disappearance period (NO in Step S52), the script processing unit 15 performs the processing of Step S52 again. On the other hand, when determining that the elapsed playback time has passed the display image disappearance period (YES in Step S52), the script processing unit 15 causes the screen control unit 14 to clear the displayed text or the displayed image on the display 4 in Step S53. Subsequently, in Step S53-1, the script processing unit 15 stops the playback of the audio file. Then, the script processing unit 15 proceeds to Step S84.

On the other hand, when determining in Step S44 that the processing type is not Type T1 (NO in Step S44), the script processing unit 15 determines in Step S54 whether the processing type is Type T2.

When determining in Step S54 that the processing type is Type T2 (YES in Step S54), the script processing unit 15 acquires the current elapsed playback time of the moving image Mv from the playback control unit 13 in Step S55.

Subsequently, in Step S56, the script processing unit 15 determines whether the current elapsed playback time is equal to a playback time defined or specified in the row of the script Sc.

When determining in Step S56 that the elapsed playback time is not equal to the playback time (NO in Step S56), the script processing unit 15 performs the processing of Step S56 again.

On the other hand, when determining that the elapsed playback time is equal to the playback time (YES in Step S56), the script processing unit 15 determines whether there is a text defined in the row of the script Sc in Step S57.

When determining in Step S57 that there is no text (NO in Step S57), the script processing unit 15 proceeds to Step S59. On the other hand, when determining that there is a text (YES in Step S57), the script processing unit 15 passes the text to the screen control unit 14 in Step S58. The screen control unit 14 displays the text passed from the script processing unit 15 on the display 4.

Subsequently, in Step S59, the script processing unit 15 acquires the current elapsed playback time of the moving image Mv from the playback control unit 13.

Subsequently, in Step S60, the script processing unit 15 determines whether the current elapsed playback time has passed the display image disappearance period defined in the row of the script Sc.

When determining in Step S60 that the elapsed playback time has not passed the display image disappearance period (NO in Step S60), the script processing unit 15 performs the processing of Step S60 again. On the other hand, when determining that the elapsed playback time has passed the display image disappearance period (YES in Step S60), the script processing unit 15 causes the screen control unit 14 to clear the displayed text on the display 4 in Step S61. Then, the script processing unit 15 proceeds to Step S84.

On the other hand, when determining in Step S54 that the processing type is not Type T2 (NO in Step S54), the script processing unit 15 determines in Step S62 whether the processing type is Type T3.

When determining in Step S62 that the processing type is Type T3 (YES in Step S62), the script processing unit 15 acquires the current elapsed playback time of the moving image Mv from the playback control unit 13 in Step S63.

Subsequently, in Step S64, the script processing unit 15 determines whether the current elapsed playback time is equal to a playback time defined or specified in the row of the script Sc.

When determining in Step S64 that the elapsed playback time is not equal to the playback time (NO in Step S64), the script processing unit 15 performs the processing of Step S64 again.

On the other hand, when determining that the elapsed playback time is equal to the playback time (YES in Step S64), the script processing unit 15 acquires the jump destination time defined in the row of the script Sc in Step S65.

Subsequently, in Step S66, the script processing unit 15 causes the playback control unit 13 to transition the moving image Mv to the acquired jump destination time. Then, the script processing unit 15 proceeds to Step S84.

On the other hand, when determining in Step S62 that the processing type is not Type T3 (NO in Step S62), the script processing unit 15 determines in Step S67 whether the processing type is Type T4.

When determining in Step S64 that the processing type is T4 (YES in Step S67), the script processing unit 15 acquires the current elapsed playback time of the moving image Mv from the playback control unit 13 in Step S68.

Subsequently, in Step S69, the script processing unit 15 determines whether the current elapsed playback time is equal to a playback time defined or specified in the row of the script Sc.

When determining in Step S69 that the elapsed playback time is not equal to the playback time (NO in Step S69), the script processing unit 15 performs the processing of Step S69 again.

On the other hand, when determining that the elapsed playback time is equal to the playback time (YES in Step S69), the script processing unit 15 directs the playback control unit 13 to stop the playback of the moving image Mv in Step S70.

Subsequently, in Step S71, the script processing unit 15 acquires a jump destination moving image file based on the jump destination moving image file information defined in the row of the script Sc, and acquires the jump destination time defined in the row of the script Sc.

In Step S72, the script processing unit 15 causes the playback control unit 13 to switch to a moving image of a moving image file indicated by the jump destination moving image file information from the moving image Mv and transition the playback of the moving image of the moving image file to the jump destination time. Then, the script processing unit 15 proceeds to Step S84.

On the other hand, when determining in Step S67 that the processing type is not Type T4 (NO in Step S67), the script processing unit 15 determines in Step S73 whether the processing type is Type T5.

When determining in Step S73 that the processing type is Type T5 (YES in Step S73), the script processing unit 15 acquires the current elapsed playback time of the moving image Mv from the playback control unit 13 in Step S74.

Subsequently, in Step S75, the script processing unit 15 determines whether the current elapsed playback time is equal to a playback time defined or specified in the row of the script Sc.

When determining in Step S75 that the elapsed playback time is not equal to the playback time (NO in Step S75), the script processing unit 15 performs the processing of Step S75 again.

On the other hand, when determining that the elapsed playback time is equal to the playback time (YES in Step S75), the script processing unit 15 directs the playback control unit 13 to ignore the playback stop instructions for the moving image Mv in Step S76.

Subsequently, in Step S77, the script processing unit 15 acquires the current elapsed playback time of the moving image Mv from the playback control unit 13.

In Step S78, the script processing unit 15 determines whether the current elapsed playback time is equal to a playback time defined or specified in the row of the script Sc.

When determining in Step S78 that the elapsed playback time is not equal to the playback time (NO in Step S78), the script processing unit 15 performs the processing of Step S78 again.

On the other hand, when determining that the elapsed playback time is equal to the playback time (YES in Step S78), the script processing unit 15 directs the playback control unit 13 to accept a playback stop instruction of the moving image Mv in Step S79. Then, the script processing unit 15 proceeds to Step S84.

On the other hand, when determining in Step S73 that the processing type is not Type T5 (NO in Step S73), the script processing unit 15 determines in Step S80 whether the processing type is Type T6.

When determining in Step S80 that the processing type is T6 (YES in Step S80), the script processing unit 15 acquires the current elapsed playback time of the moving image Mv from the playback control unit 13 in Step S81.

Subsequently, in Step S82, the script processing unit 15 determines whether the current elapsed playback time is equal to a playback time defined or specified in the row of the script Sc.

When determining in Step S82 that the elapsed playback time is not equal to the playback time (NO in Step S82), the script processing unit 15 performs the processing of Step S82 again.

On the other hand, when determining that the elapsed playback time is equal to the playback time (YES in Step S82), the script processing unit 15 directs the playback control unit 13 to end the playback of the moving image Mv in Step S83.

On the other hand, in Step S80, when determining that the processing type is not T6 (Step S80, NO), the script processing unit 15 proceeds to Step S84.

Subsequently, in Step S84, the script processing unit 15 determines whether the next row is present in the script Sc. When it is determined in Step S84 that there is a next row (YES in Step S84), the script processing unit 15 performs the processing from Step S41 again.

On the other hand, when determining in Step S84 that there is no next row (NO in Step S84), the script processing unit 15 ends the process.

As described above, the script processing unit 15 can execute the processing defined in each row of the table of the script Sc in order from the first row based on the script Sc.

### Example of Playback of Moving Image Mv

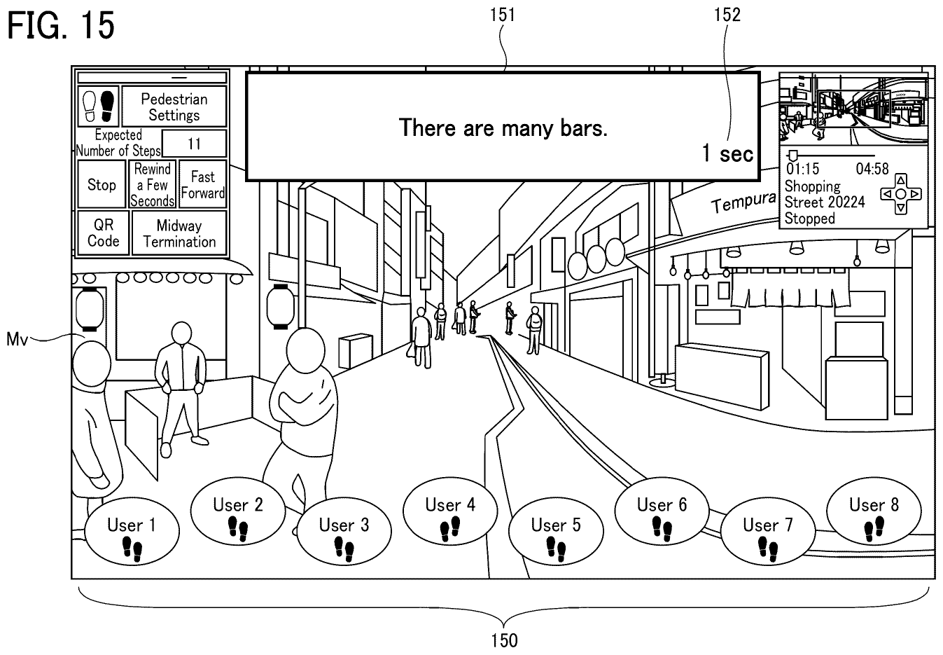

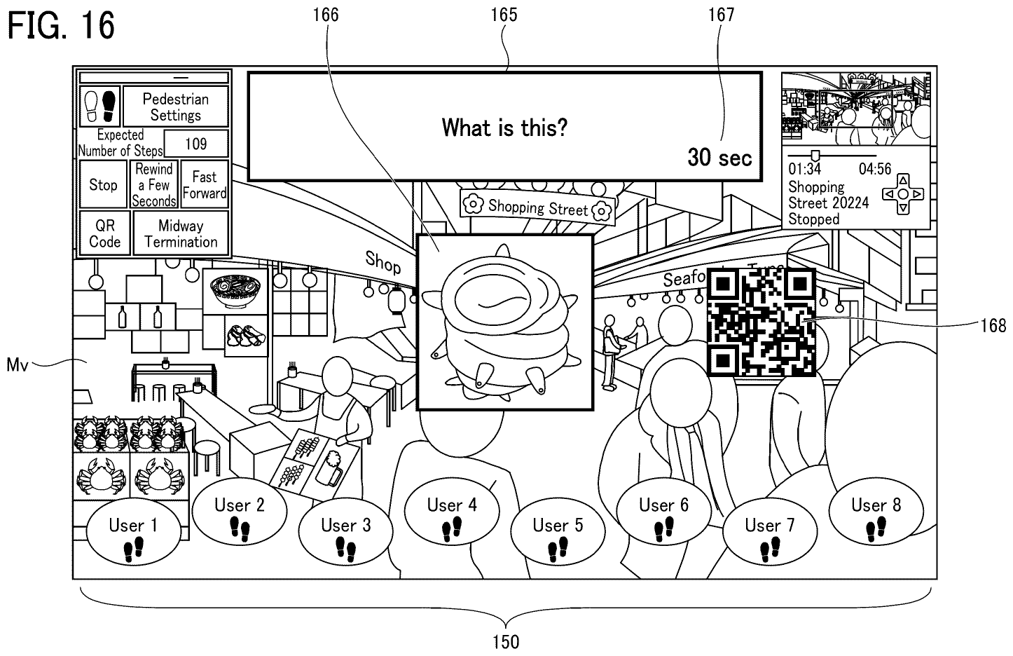

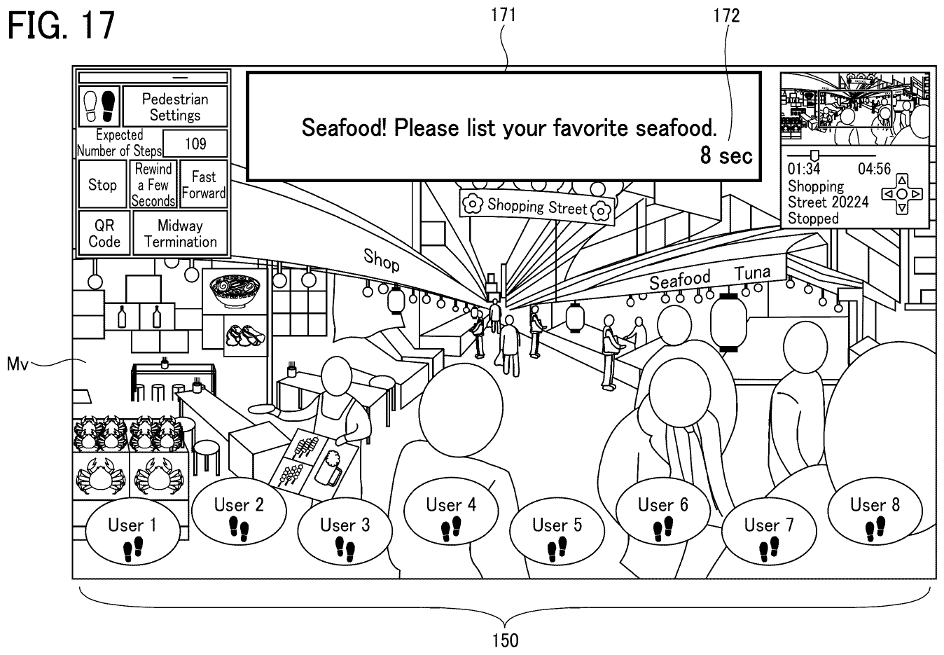

FIGS. 15 to 17 are diagrams each illustrating a screen of the moving image Mv displayed on the display 4 in the information processing system 100. FIG. 15 is a first example of the screen of the moving image Mv, FIG. 16 is a second example of the screen of the moving image Mv, and FIG. 17 is a third example of the screen of the moving image Mv.

In the first example illustrated in FIG. 15, a comment text 151 representing a comment of “There are many bars.”, a comment display remaining time 152, and icons 150 serving as user icons are displayed superimposed on the moving image Mv. The comment display remaining time 152 indicates the remaining time for which the comment text 151 is displayed. The comment display remaining time 152 can display the remaining time in a countdown manner. The icons 150 indicate the users U who are using the information processing system 100. The screen control unit 14 can display the comment text 151, the comment display remaining time 152, and the icons 150 superimposed on the moving image Mv in response to a command from the script processing unit 15.

In the second example illustrated in FIG. 16, a quiz text 165 representing a quiz of “What is this?, a quiz image 166 related to the quiz, a quiz display remaining time 167 indicating a remaining time for which the quiz text 165 is displayed, a code image 168, and the icons 150 serving as the user icons are displayed superimposed on the moving image Mv. The quiz display remaining time 167 can display the remaining time in a countdown manner. The code image 168 displays a QR code (registered trademark) for providing information related to the screen displayed by the moving image Mv. The users U can view information related to the screen displayed by the moving image Mv through an information terminal such as a smartphone by capturing an image of the QR code of the code image 168 with a camera of the information terminal.

In the second example illustrated in FIG. 16, the script processing unit 15 can cause the screen control unit 14 to display the quiz text 165 for the users U on the display 4 during or after the playback of the moving image Mv, and can cause the display 4 to display an answers of each user U to the quiz of the quiz text 165 or can cause the storage unit 16 to store the answer. The information processing system 100 can record the result of what action each user U has taken with respect to the quiz and analyze for, for example, the memory ability or the judgment ability of the user U.

In the third example illustrated in FIG. 17, a request text 171 representing a request of “Seafood! Please list your favorite seafood.”, a request display remaining time 172 indicating a remaining time for which the request text 171, and the icons 150 serving as the user icons of the users U who are using the information processing system 100 are displayed in a superimposed manner on the moving image Mv. The request display remaining time 172 can display the remaining time in a countdown manner. A question can be replaced with a request.

### Second Embodiment

A program according to a second embodiment of the present disclosure and a computer that causes the program to execute processing are described below.

The program according to the second embodiment of the present disclosure is a program for creating a script Sc. For example, the program is available by installing the program on a computer by the creator of the script Sc, such as a physical therapist, or by downloading the program in a computer by the creator from the server 300 via the network N.

The computer that causes the program according to the second embodiment of the present disclosure to execute processing is, for example, the information processing apparatus 1 described above. In the following description, it is assumed that the computer is the information processing apparatus 1, and the information processing apparatus 1 in the information processing system 100 is replaced with the computer. However, the computer is not limited to the information processing apparatus 1, and may be any device such as an information processing apparatus or an information processing terminal that is not included in the information processing system 100. The information processing apparatus or the information processing terminal includes a smartphone, a tablet, and a laptop PC.

### Example of Functional Configuration

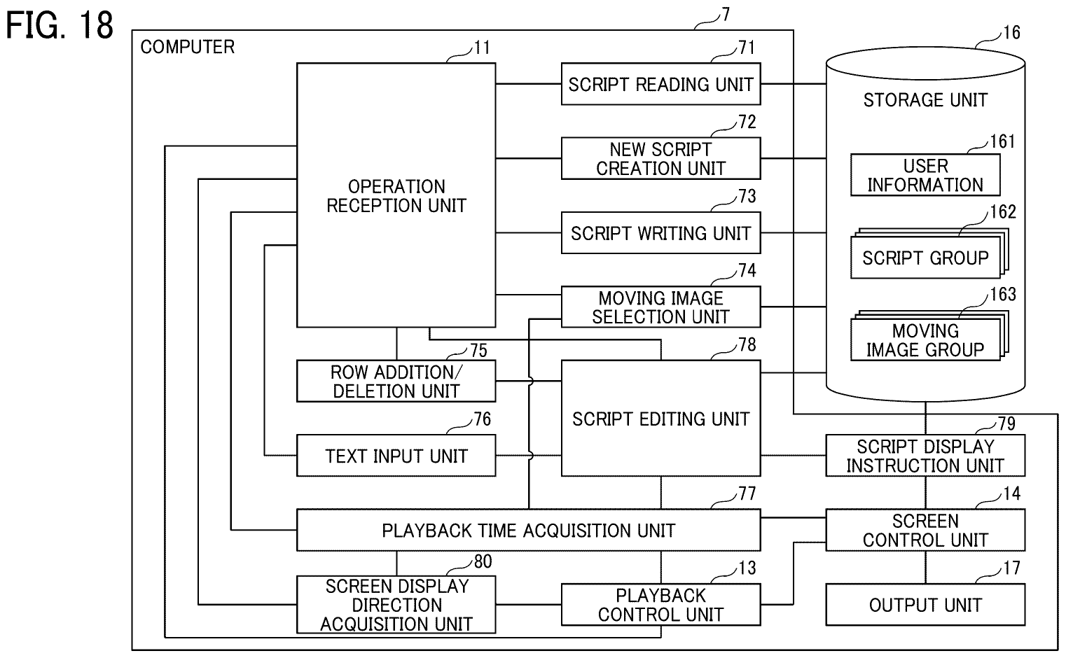

FIG. 18 is a block diagram illustrating an example of a functional configuration of a computer 7 that causes a program according to the second embodiment of the present disclosure to execute processing. In the example illustrated in FIG. 18, the computer 7 includes a script reading unit 71, a new script creation unit 72, a script writing unit 73, a moving image selection unit 74, a row addition/deletion unit 75, a text input unit 76, a playback time acquisition unit 77, a script editing unit 78, a script display instruction unit 79, and a screen display direction acquisition unit 80.

The program according to the second embodiment of the present disclosure causes the computer 7 to execute, by the moving image selection unit 74, processing of selecting a moving image Mv according to a selection operation input by the user. The moving image Mv is for a script Sc in which a first command Cm1 to control the playback in association with a specific playback time (first playback time) of the moving image Mv and a second command Cm2 to control the display in association with a specific playback time (second playback time) of the moving image Mv are described. The program causes the computer 7 to execute, by the playback time acquisition unit 77, processing of displaying the moving image Mv selected by the moving image selecting unit 74 on the display 4 and acquiring information on the playback time related to a control command corresponding to at least one of the first command Cm1 and the second command Cm2 in the script Sc. Further, the program causes the computer 7 to execute, by the script editing unit 78, processing of describing each of the first command Cm1 and the second command Cm2 in the script Sc in association with the playback time acquired by the playback time acquisition unit 77.

The computer 7 can execute processing for creating a script Sc. In the present embodiment of the present disclosure, a moving image Mv suitable for the user U or the operator 200 can be easily provided by using a script Sc created by the computer 7.

The script reading unit 71 reads the file of an existing script Sc from the script group 162 stored in the storage unit 16 in response to an operation input of the operator received via the operation reception unit 11.

The new script creation unit 72 opens a file for newly creating a script Sc in response to an operation input of the operator received via the operation reception unit 11.

The script writing unit 73 writes a file obtained by editing the existing script Sc or a file of the newly created script Sc to an external device or an external apparatus in response to an operation input of the operator received via the operation reception unit 11. The external device includes the storage unit 16 and the display 4. The external device may be the server 300 connected via the network N.

As described above, the moving image selection unit 74 selects a moving image Mv for the script Sc in response to a selection operation by the operator. In the example illustrated in FIG. 18, the moving image selection unit 74 receives a selection operation input by the operator via the operation reception unit 11. The moving image selection unit 74 can select a moving image Mv corresponding to the received selection operation input from the moving image group 163 stored in the storage unit 16.

The row addition/deletion unit 75 adds or deletes a row corresponding to processing in the table of the script Sc according to an operation input of the operator received via the operation reception unit 11.

The text input unit 76 inputs a text corresponding to a command to the table of the script Sc in response to an operation input of the operator received via the operation reception unit 11.

As described above, the playback time acquisition unit 77 causes the display 4 to display the moving image Mv selected by the moving image selection unit 74, and acquires the playback time related to a control command corresponding to at least one of the first command Cm1 and the second command Cm2 in the script Sc. In the example illustrated in FIG. 18, the playback time acquisition unit 77 causes the display 4 to display the moving image Mv received from the moving image selection unit 74 via the screen control unit 14. The playback time acquisition unit 77 acquires information on the playback time related to a control command corresponding to at least one of the first command Cm1 and the second command Cm2 in response to an input operation of the operator received by the moving image selection unit 74 via the operation reception unit 11, and passes the information to the script editing unit 78.

As described above, the script editing unit 78 describes the first command Cm1 or the second command Cm2 in the script Sc in association with the playback time acquired by the playback time acquisition unit 77. In the example illustrated in FIG. 18, the script editing unit 78 generates information indicating the first command Cm1 or the second command Cm2 in response to an operation input of the operator received via the operation reception unit 11. The script editing unit 78 can describe the information indicating the first command Cm1, the second command Cm2 or the audio file in the script Sc in association with the playback time indicated by the information on the playback time received from the playback time acquisition unit 77.

The script display instruction unit 79 extracts from the script Sc stored in the storage unit 16 a text, an image, or audio file according to an instruction from the script editing unit 78, and passes the extracted file to the screen control unit 14 or the audio control unit 14-1.

The screen display direction acquisition unit 80 passes to the playback control unit 13 information on the direction of the screen viewed by the user U when the script Sc is created using the computer 7 in response to an operation input of the operator received via the operation reception unit 11. The playback control unit 13 can change the image area of the moving image Mv displayed on the display 4 by the screen control unit 14 according to the received information on the screen direction.

### Example of Processing by Computer 7

### Overall Process

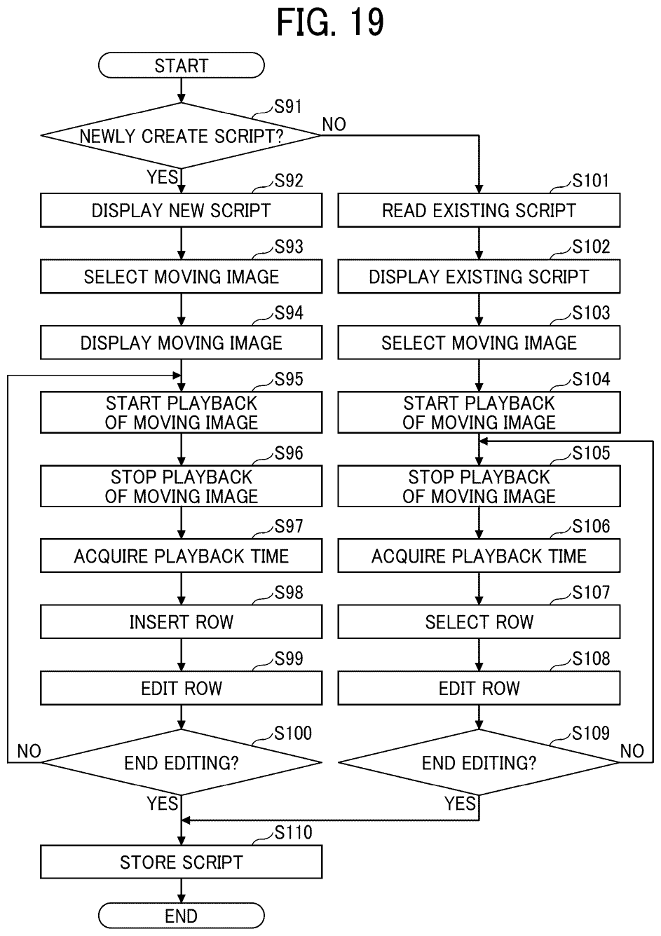

FIG. 19 is a flowchart illustrating an example of an overall process performed by the computer 7.

FIG. 19 illustrates an overall process performed by the computer 7 when a creator of a script Sc creates the script Sc using the computer 7. For example, the computer 7 starts the process of FIG. 19 on the condition that the operation reception unit 11 receives an operation of activating a program for creating a script Sc.

First, in Step S91, the computer 7 determines whether to newly create a script Sc. The computer 7 can determine whether to newly create a script Sc according to an operation received by the operation reception unit 11.

When determining in Step S91 that a new script is to be created (YES in Step S91), the computer 7 creates a new script Sc by the new script creation unit 72 in Step S92, and causes the display 4 to display the table of the new script Sc via the screen control unit 14 by the script display instruction unit 79. The creator can create the script Sc while viewing the table of the script Sc displayed on the display 4.

Subsequently, in Step S93, the computer 7 selects, by the moving image selection unit 74, a moving image Mv for the script Sc according to an operation received by the operation reception unit 11.

The moving image selection unit 74 passes the selected moving image Mv to the playback time acquisition unit 77.

Subsequently, in Step S94, the computer 7 causes the screen control unit 14 to display the moving image Mv received by the playback time acquisition unit 77 from the moving image selection unit 74 on the display 4.

Subsequently, in Step S95, the computer 7 starts the playback of the moving image Mv by the playback control unit 13 in response to an operation received by the operation reception unit 11. For the playback, for example, fast-forward playback or jump playback for which a playback time is directly specified may be used.

Subsequently, in Step S96, the computer 7 stops the playback of the moving image Mv by the playback control unit 13 in response to an operation received by the operation reception unit 11. For example, the creator plays the moving image Mv until the playback time at which the creator wants to give a command, such as a command to display a text, and stops the playback of the moving image Mv when the moving image Mv is played until the playback time at which the creator wants to give the command comes.

Subsequently, in Step S97, the computer 7 acquires information on the playback time by the playback time acquisition unit 77. The playback time acquisition unit 77 passes the acquired information on the playback time to the script editing unit 78.

Subsequently, in Step S98, the computer 7 inserts a row into the table of the script Sc by the row addition/deletion unit 75 according to an operation received by the operation reception unit 11.

Subsequently, in Step S99, the computer 7 edits the row inserted in the table of the script Sc by the script editing unit 78 according to an operation received by the operation reception unit 11. The script editing unit 78 can input a text or information other than a text to the row of the script Sc via the text input unit 76.

Subsequently, in Step S100, the computer 7 determines whether to end the editing. For example, the computer 7 can determine whether to end the editing according to an operation received by the operation reception unit 11.

When determining in Step S100 that the processing is not ended (NO in Step S100), the computer 7 performs the processing from Step S95 again. On the other hand, when determining that the processing is ended (YES in Step S100), the computer 7 proceeds to Step S110.

On the other hand, when determining in Step S91 that the script Sc is not newly created (NO in Step S91), the computer 7 reads an existing script Sc stored in the storage unit 16 by the script reading unit 71 in Step S101.

Subsequently, in Step S102, the computer 7 causes the script display instruction unit 79 to display the table of the existing script Sc on the display 4 via the screen control unit 14. The creator can create a script Sc while viewing the table of the script Sc displayed on the display 4.

Subsequently, in Step S103, the computer 7 selects, by the moving image selection unit 74, a moving image Mv for the script Sc according to an operation received by the operation reception unit 11. The moving image selection unit 74 passes the selected moving image Mv to the playback time acquisition unit 77.

Subsequently, in Step S104, the computer 7 causes the screen control unit 14 to display the moving image Mv received by the playback time acquisition unit 77 from the moving image selection unit 74 on the display 4.

Subsequently, in Step S105, the computer 7 starts the playback of the moving image Mv by the playback control unit 13 in response to an operation received by the operation reception unit 11. For the playback, for example, fast-forward playback or jump playback for which a playback time is directly specified may be used.

Subsequently, in Step S106, the computer 7 stops the playback of the moving image Mv by the playback control unit 13 in response to an operation received by the operation reception unit 11. For example, the creator plays the moving image Mv until the playback time at which the creator wants to give a command, such as a command to display a text, and stops the playback of the moving image Mv when the moving image Mv is played until the playback time at which the creator wants to give the command comes.

Subsequently, in Step S107, the computer 7 selects a row to be edited in the table of the script Sc by the script editing unit 78 in response to an operation received by the operation reception unit 11.

Subsequently, in Step S108, the computer 7 edits the selected row by the script editing unit 78 according to an operation received by the operation reception unit 11. The script editing unit 78 can input a text or information other than a text to the item of the row via the text input unit 76.

Subsequently, in Step S109, the computer 7 determines whether to end the editing. For example, the computer 7 can determine whether to end the editing according to an operation received by the operation reception unit 11.

When determining in Step S109 that the processing is not to be ended (NO in Step S109), the computer 7 performs the processing from Step S105 again. On the other hand, when determining that the processing is ended (YES in Step S109), the computer 7 proceeds to Step S110.

Subsequently, in Step S110, the computer 7 stores the script Sc by the script editing unit 78. The saved script Sc is stored in the storage unit 16.

As described above, the computer 7 can execute the process of creating a script Sc.

### Row Editing Process

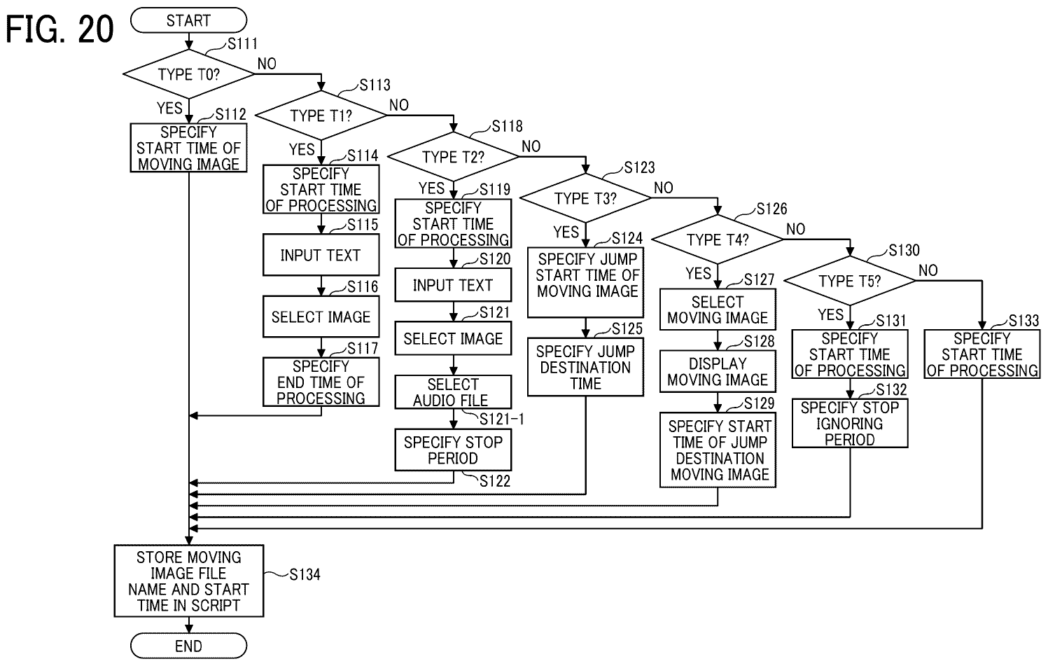

FIG. 20 is a flowchart illustrating an example of a row editing process executed by the script editing unit 78. FIG. 20 illustrates a process executed by the script editing unit 78 when the creator of the script Sc edits a row of a script Sc using the computer 7. For example, the script editing unit 78 starts the process of FIG. 20 on the condition that the process illustrated in FIG. 19 reaches either Step S99 or Step S108.

First, in Step S111, the script editing unit 78 determines whether the processing type is Type T0.

When determining in Step S111 that the processing type is Type T0 (YES in Step S111), the script editing unit 78 inputs and specifies a time to start the moving image Mv in the row in Step S112. Then, the script editing unit 78 proceeds to Step S134. On the other hand, when determining in Step S111 that the processing type is not Type T0 (NO in Step S111), the script editing unit 78 determines in Step S113 whether the processing type is Type T1.

When determining in Step S113 that the processing type is Type T1 (YES in Step S113), the script editing unit 78 inputs and specifies a time to start the processing in the row in Step S114.

Subsequently, in Step S115, the script editing unit 78 inputs a text to be displayed.

Subsequently, in Step S116, the script editing unit 78 selects an image to be displayed.

In Step S117, the script editing unit 78 inputs and specifies a time to end the processing in the row. Then, the process proceeds to Step S134.

On the other hand, when determining in Step S113 that the processing type is not Type T1 (NO in Step S113), the script editing unit 78 determines in Step S118 whether the processing type is Type T2.

When determining in Step S118 that the processing type is T2 (YES in Step S118), the script editing unit 78 inputs and specifies a time to start the processing in the row in Step S119.

Subsequently, in Step S120, the script editing unit 78 inputs a text to be displayed.

Subsequently, in Step S121, the script editing unit 78 selects an image to be displayed.

Then, an audio file to be played is selected in the script S121-1.

In Step S122, the script editing unit 78 inputs and specifies a playback stop period in the row. Then, the process proceeds to Step S134.

On the other hand, when determining in Step S118 that the processing type is not Type T2 (NO in Step S118), the script editing unit 78 determines in Step S123 whether the processing type is Type T3.

When determining in Step S123 that the processing type is T3 (YES in Step S123), the script editing unit 78 inputs and specifies a jump start time in the moving image Mv in the row in Step S124.

Subsequently, in Step S125, the script editing unit 78 inputs and specifies a jump destination time in the moving image Mv in the row. Then, the process proceeds to Step S134.

On the other hand, when determining in Step S123 that the processing type is not Type T3 (NO in Step S123), the script editing unit 78 determines in Step S126 whether the processing type is Type T4.

In Step S126, when determining that the processing type is T4 (Step S126, YES), the script editing unit 78 selects a moving image Mv in Step S127.

Subsequently, in Step S128, the script editing unit 78 displays the moving image Mv.

Subsequently, in Step S129, the script editing unit 78 inputs and specifies a time to start a jump destination moving image in the row. Then, the process proceeds to Step S134.

On the other hand, when determining in Step S126 that the processing type is not Type T4 (NO in Step S126), the script editing unit 78 determines in Step S130 whether the processing type is Type T5.

When determining in Step S130 that the processing type is Type T5 (YES in Step S130), the script editing unit 78 inputs and specifies a time to start the processing in the row in Step S131.

Subsequently, in Step S132, the script editing unit 78 inputs and specifies a stop instruction ignoring period in the row. Then, the process proceeds to Step S134.

On the other hand, when determining in Step S130 that the processing type is not Type T5 (NO in Step S130), the script editing unit 78 inputs and specifies a time to start the processing in the row in Step S133. Then, the process proceeds to Step S134.

Subsequently, in Step S134, the script editing unit 78 stores the moving image file name and the start time in the script Sc.

As described above, the script editing unit 78 can execute the process when the creator of the script Sc edits the row of the script Sc using the computer 7.

### Example of Script Creation Screen

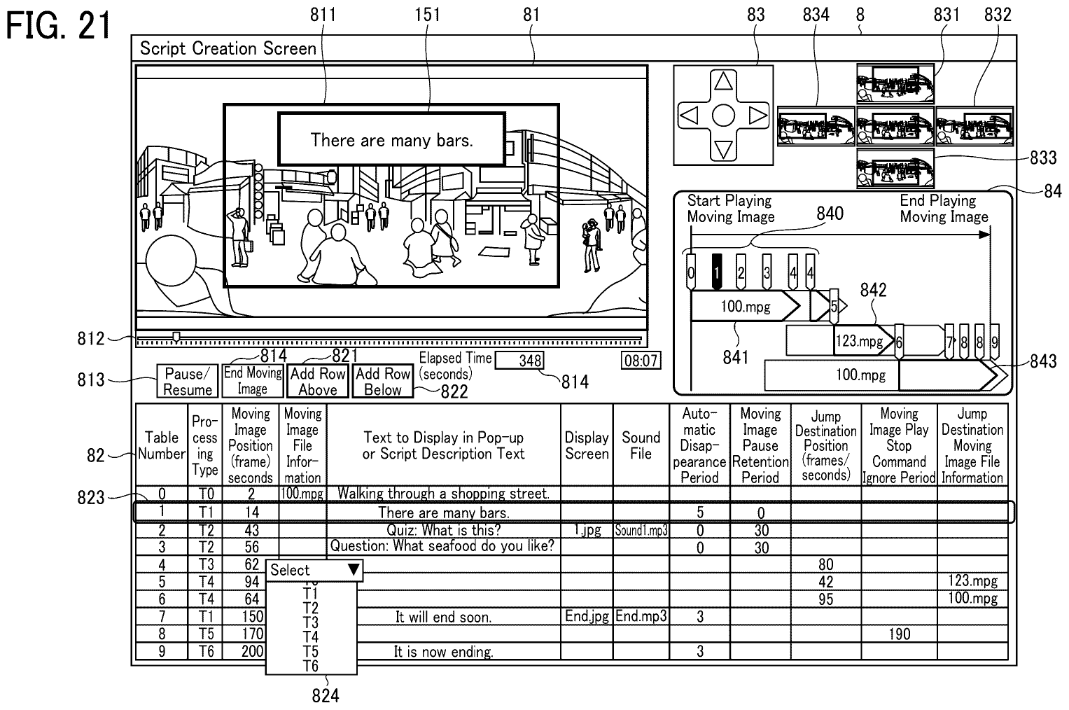

FIG. 21 is a diagram illustrating an example of a script creation screen 8 displayed by the computer 7. The script creation screen 8 is a screen displayed on, for example, the display 4 when the computer 7 creates a script Sc.

In the example illustrated in FIG. 21, the script creation screen 8 includes a moving image display section 81, a table display section 82, an image area display section 83, and a timetable display section 84.

The moving image display section 81 is a screen area for displaying a moving image Mv for which a script Sc is to be created. In the example illustrated in FIG. 21, the moving image display section 81 includes a frame 811, a time indicator 812, a pause/resume button 813, and a moving image end button 814. A frame 811 indicates an area of the image of the moving image Mv displayed on the display 4 in the information processing system 100. The time indicator 812 indicates the playback time of the moving image Mv. The pause/resume button 813 is a button operated when pausing or resuming the playback of the moving image Mv. The moving image end button 814 is a button operated when the playback of the moving image Mv is ended.

The table display section 82 includes an upper row addition button 821, a lower row addition button 822, an edited row 823, and a selection box 824. The upper row addition button 821 is a button operated when a new row is added to above a row in the table of the script Sc. The lower row addition button 822 is a button operated when a new row is added to below a row in the table of the script Sc. The edited row 823 is a row being edited. The selection box 824 is a user interface (UI) for displaying predetermined processing Types T1 to T6 and allowing the creator to select any of the processing types.

The image area display section 83 is used to set an area in the moving image Mv that is visually recognized by the user U of the information processing system 100. An upper area 831 corresponds to the upper part of the moving image Mv and is to be displayed when the upper part of the moving image Mv is specified, a right area 832 corresponds to the right part of the moving image Mv and is to be displayed when the right part of the moving image Mv is specified, a lower area 833 corresponds to the lower part of the moving image Mv and is to be displayed when the lower part of the moving image Mv is specified, and a left area 834 corresponds to the left part of the moving image Mv and is to be displayed when the left part of the moving image Mv is specified.

The timetable display section 84 is a view for checking the displayed moving image Mv and the script Sc. For example, the timetable display section 84 is used to check the playback time of a command in the moving image Mv.

In the script Sc illustrated in FIG. 21, three moving images, a first moving image, a second moving image, and a third moving image, are temporally connected to each other and played and displayed on the display 4. A first moving image mark 841 corresponds to a first moving image to be displayed first on the display 4. A second moving image mark 842 corresponds to a second moving image to be displayed second on the display 4. The third moving image mark 843 corresponds to a third moving image to be displayed third on the display 4. In the example illustrated in FIG. 21, the three moving images are displayed in order. The first moving image is displayed on the display 4 in the time zone displayed by the first moving image mark 841. The second moving image is displayed on the display 4 in the time zone displayed by the second moving image mark 842. The third moving image is displayed on the display 4 in the time zone displayed by the third moving image mark 843.

Each of multiple command marks 840 is a mark for a playback time at which a command is present in the moving image Mv. The number in the command mark 840 represents a row number in the table. When one of the multiple command marks 840 is selected by, for example, clicking, the corresponding row can be edited in the table display section 82.

The creator can create a script Sc using the script creation screen 8 as illustrated in FIG. 21.

### Third Embodiment

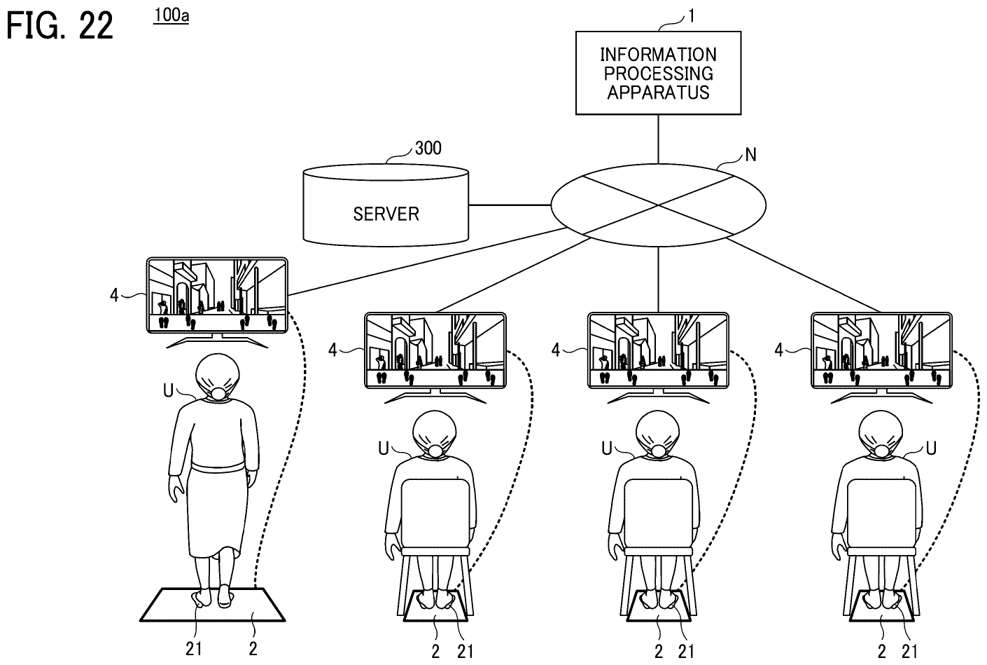

An information processing system according to a third embodiment of the present disclosure is described below. FIG. 22 is a diagram illustrating an example of a configuration of an information processing system 100a according to the third embodiment of the present disclosure.

The information processing system 100a is different from the above described embodiments and the above-described variation examples in that multiple users U each being at a remote site can share the same moving image to perform a walking exercise.

In the example illustrated in FIG. 22, the information processing apparatus 1, the displays 4 used by the respective users U, and the motion sensors 2 used by the respective users U are communicably connected to each other via a network. The display 4 includes a PC, a tablet, and a smartphone. The acquisition unit 12 of the information processing apparatus 1 can acquire motion state information of the users U via the network, and the output unit 17 can distribute moving image data and data to be displayed on the displays 4 to the multiple displays 4 in a streaming format.

The information processing system 100a allows the users U who are distant from each other to feel a sense of realism that the users U are exercising at the same place. In the example illustrated in FIG. 22, the motion sensor 2 is connected to the display 4 in a wired or wireless manner, and can transmit the motion state information to the information processing apparatus 1 via the display 4. However, the motion sensor 2 may be directly connected to the network and transmit the motion state information to the information processing apparatus 1 without the display 4. In the example illustrated in FIG. 22, the server 300 illustrated in FIG. 5 includes the storage unit 16 and holds the script, the moving image, and the user information. However, the information processing apparatus 1 may include the storage unit 16.

The size of the moving image distributed in the information processing system 100a may be changed as appropriate depending on the device included in the display 4. For example, the information processing apparatus 1 can acquire information on the type of the device of the display 4 used by the user U and the performance of the CPU and the memory from the display 4 and distribute a moving image with a data capacity suitable for the device. The data capacity can be adjusted by adjusting the resolution, the frame rate, or the bit rate.

Thus, in the device of the display 4 having a low processing speed, the data capacity is reduced and the moving image is distributed. Accordingly, even when the users U use devices whose processing speeds differ from each other, all the users can participate in the exercise while viewing the common moving image.

The relationship between the eye level of the user U and the height of the display 4 may vary depending on the usage of the user U. For example, the relationship between the eye level of the user U and the height of the display 4 differs between a case where the user U performs a walking exercise by standing up and a case where the user U performs a walking exercise by sitting on a chair. The relationship between the eye level of the user U and the height of the display 4 may also vary depending on the installation environment of the display 4 used by the user U. Accordingly, in the information processing system 100a, control for adjusting the eye level position and the display height or inclination of an image displayed on the display 4 may be performed before the playback of the moving image is started. By adjusting the eye level position and the display height and inclination of the image displayed on the display 4, each of the multiple users U can easily view the moving image according to the usage.

In the related art, a moving image that includes an element in which a user is interested or an element that is effective for rehabilitation is not always provided, that is, a moving image to be played is not tailored to the user. Further, a lot of time and effort is taken to create a moving image suitable for a user by editing a moving image to be played.

According to an aspect of the present disclosure, a moving image suitable for a user can be easily provided.

Although some embodiments and variations have been described above, embodiments and variations of the present disclosure are not limited to the above-described embodiments and variations. Various modifications and substitutions may be made to the above-described embodiments and variations without departing from the scope described in the appended claims.

The numbers such as ordinal number and quantity used in the description of the above embodiments are all illustrative for the purpose of describing the technology of the embodiments of the present disclosure, and the embodiments of the present disclosure are not limited to the illustrative numbers. Further, a connection relation between the components is exemplified for the purpose of describing the technology of the embodiments of the present disclosure, and the connection relation to enable the functions of the present disclosure is not limited to the connection relation as described above.

The division of blocks in the functional block diagrams is provided as an example. Some blocks may be implemented as a single block, a single block may be divided into multiple blocks, or some functions may be moved to other blocks. The functions of some blocks with similar functions may be processed in parallel or in a time-division manner by a single unit of hardware or software. Some or all functions may be distributed across multiple computers.

Aspects of the present disclosure are, for example, as follows.

### Aspect 1

An information processing apparatus includes a playback control unit to control the playback of a moving image displayed on a display according to a motion state of a user, a screen control unit to control the screen of the display, and a script processing unit to direct the playback control unit and the screen control unit to perform control based on a script. In the script, a first command directing the playback control unit to control the playback in association with a specific playback time (first playback time) of the moving image and a second command directing the screen control unit to control the screen in association with a specific playback time (second playback time) are described.

### Aspect 2

The information processing apparatus according to Aspect 1 further includes a storage unit that stores the script. The script processing unit directs the playback control unit and the screen control unit to perform control based on the script stored in the storage unit.

### Aspect 3

In the information processing apparatus according to Aspect 2, the storage unit stores the script corresponding to the user or a group of multiple users. The script processing unit acquires the script corresponding to the user or the group of the multiple users by referring to the storage unit in response to a selection input indicating the user or the group of the multiple users.

### Aspect 4

In the information processing apparatus according to Aspect 2 or Aspect 3, the script processing unit causes the screen control unit to display a quiz for the user on the display and causes the display to display or causes the storage unit to store an answer of the user to the quiz, during or after the playback of the moving image.

### Aspect 5

The information processing apparatus according to any one of Aspect 1 to Aspect 4 further includes a motion sensor that outputs motion state information indicating the motion state of the user.

### Aspect 6

The information processing apparatus according to Aspect 5 further includes the display that displays the moving image whose playback is controlled according to the motion state of the user. The display is a head-mounted display device or glasses-type display device.

### Aspect 7

An information processing system includes the information processing apparatus according to any one of Aspect 1 to Aspect 4 and a server that is communicably connected to the information processing apparatus and transmits the moving image and the script to the information processing apparatus in response to a request from the information processing apparatus.

### Aspect 8

In the information processing system according to Aspect 7, the information processing apparatus transmits the moving image to the display via a network.

### Aspect 9

The information processing system according to Aspect 7 further includes a motion sensor to transmit motion state information indicating the motion state of the user to the information processing apparatus via a network.

### Aspect 10

A program causes a computer to control, by a playback control unit, the playback of a moving image displayed on a display according to a motion state of a user, control, by a screen control unit, the screen of the display, and direct the playback control unit and the screen control unit to perform control based on a script. In the script, a first command for directing the playback control unit to control the playback in association with a specific playback time (first playback time) of the moving image and a second command for directing the screen control unit to control the screen of the display in association with a specific playback time (second playback time) are described.

### Aspect 11

A program causes a computer to select, by a moving image selection unit, a moving image for a script. In the script, a first command to control the playback of the moving image in association with a specific playback time (first playback time) of the moving image and a second command to control the screen in association with a specific playback time (second playback time) are described. The program causes the computer to display the moving image and acquire information on the playback time to direct to perform control according to at least one of the first command and the second command in the script, by a playback time acquisition unit, and describe, by a script editing unit, at least one of the first command and the second command in association with the playback time acquired by the playback time acquisition unit.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus, comprising circuitry configured to:
play a moving image displayed on a display according to a motion state of a user; and
control a playback of the moving image and a screen of the display based on a script including a first command and a second command, wherein
the first command describes controlling the playback of the moving image in association with a first playback time of the moving image, and
the second command describes controlling the screen of the display in association with a second playback time of the moving image.

2. The information processing apparatus of claim 1, further comprising a memory that stores the script.

3. The information processing apparatus of claim 2, wherein
the user includes a single user and a plurality of users,
the script includes a first script and a second script, the first script corresponding to the single user, the second script corresponding to a group of the plurality of the users, and
the circuitry is configured to acquire one of the first script and the second script from the memory according to an input for selecting a corresponding one of the single user and the group of the plurality of users.

4. The information processing apparatus of claim 2, wherein
the circuitry is configured to display, on the display, a quiz for the user during or after the playback of the moving image; and
display on the display, or store in the memory, an answer of the user to the quiz.

5. The information processing apparatus of claim 1, wherein
the script describes, in association with the second playback time of the moving image, at least one of a text to be displayed on the display or a file name of an image to be displayed on the display.

6. The information processing apparatus of claim 5, wherein
in a case that the text to be displayed on the display is described in the script, a period for displaying the text on the display is described in the script in association with the second playback time of the moving image, and
in a case that the file name of the image to be displayed on the display is described in the script, another period for displaying the image on the display is described in the script in association with the second playback time of the moving image.

7. The information processing apparatus of claim 1, wherein
the script describes the first playback time in association with an additional playback time corresponding to a jump destination of the moving image.

8. The information processing apparatus of claim 1, wherein
the script describes the first playback time in association with another file name of another moving image that is different from the moving image, said another moving image being a jump destination.

9. The information processing apparatus of claim 1, wherein
the script describes a predetermined processing type in association with one of a plurality of playback times including the first playback time and the second playback time of the moving image.

10. The information processing apparatus of claim 9, wherein
the circuitry is configured to control the playback of the moving image in association with the one of the plurality of playback times described in the script, based on the processing type.

11. An information processing system, comprising:
the information processing apparatus of claim 1; and
a motion sensor to output motion state information indicating the motion state of the user.

12. The information processing system of claim 11, further comprising
the display that displays the moving image, wherein
the display is one of a head-mounted display device and a glasses-type display device.

13. An information processing system, comprising:
the information processing apparatus of claim 1; and
a server communicably connected to the information processing apparatus and including additional circuitry, wherein
the additional circuitry is configured to transmit the moving image and the script to the information processing apparatus in response to a request from the information processing apparatus.

14. The information processing system of claim 13, wherein
the circuitry is configured to transmit the moving image to the display via a network.

15. The information processing system of claim 13, further comprising
a motion sensor to transmit motion state information indicating the motion state of the user to the information processing apparatus via a network.

16. A non-transitory recording medium storing a plurality of instructions which, when executed by one or more processors, causes the processors to perform a method, the method comprising:
playing a moving image displayed on a display according to a motion state of a user; and
controlling playback of the moving image and a screen of the display based on a script including a first command and a second command, wherein
the first command describes the controlling the playback of the moving image in association with a first playback time of the moving image, and
the second command describes the controlling the screen of the display in association with a second playback time of the moving image.

17. An information processing method, comprising:
playing a moving image on a display according to a motion state of a user;
acquiring a first playback time of the moving image;
acquiring a second playback time of the moving image;
executing a first command to control playback of the moving image displayed on the display in association with the first playback time; and
executing a second command to control a screen of the display in association with the second playback time, wherein
the first command and the second command are described in a script.
